(19) United States
(12) Patent Application Publication
(10) Pub. No.: US 2015/0348496 A1
(43) Pub. Date: Dec. 3, 2015

(54) SYSTEMS AND METHODS FOR SELECTING DISPLAY OPERATION MODES

(71) Applicant: Pixtronix, Inc., San Diego, CA (US)

(72) Inventors: Theodore Richard Santos, II, Boulder, CO (US); Gregory Paul Heinzinger, Del Mar, CA (US); Shiae Shin Park, San Diego, CA (US); Mark Jerger, San Diego, CA (US); Mark Douglas Halfman, Newtonville, MA (US); Brian Finkel, Acton, MA (US); Jonathan Karl Kies, Encinitas, CA (US)

(21) Appl. No.: 14/723,280

(22) Filed: May 27, 2015

Related U.S. Application Data
(60) Provisional application No. 62/005,901, filed on May 30, 2014.

(51) Int. Cl. G09G 5/00; G06F 3/0484; G06F 3/0482

(52) U.S. Cl. CPC G09G 5/003; G06F 3/0482; G06F 3/04842; G06F 3/04847; G09G 2354/00

(57) ABSTRACT

This disclosure provides systems, methods and apparatus for selecting display operation modes for displaying content on a display device. The display device can utilize user selectable display operation modes for displaying content. Various display operation modes, based on various values of display parameters such as frame rate, color bit depth, maximum brightness level, color gamut, percentages of color gamut, white point, gamma, and the number of subframes or bit-planes per image frame can be presented, for example, to a user, for selection using a user interface. The user interface can be capable of providing the ability to select global display operation modes for all applications running on the display device or to assign display operation modes in-focus applications running on the display device. In some implementations, the display device can automatically select the appropriate display operation mode based, at least, on the content being displayed.

### CROSS-REFERENCE TO RELATED APPLICATIONS

This patent application claims priority to U.S. Provisional Patent Application No. 62/005,901 entitled “Systems and Methods for Selecting Display Modes of a Display,” filed May 30, 2014, assigned to the assignee hereof and hereby expressly incorporated by reference herein.

### TECHNICAL FIELD

This disclosure relates to the field of displays, and in particular, to methods and systems for controlling display operation modes of the displays.

### SUMMARY

The systems, methods and devices of the disclosure each have several innovative aspects, no single one of which is solely responsible for the desirable attributes disclosed herein.

One innovative aspect of the subject matter described in this disclosure can be implemented in an electronic device including a display capable of generating images according to a plurality of variable display parameters, a processor coupled to the display, capable of executing a plurality of software applications on the electronic device, and a display control module. The display control module is capable of maintaining a display operation mode data structure including a plurality of display operation modes and values of display parameters corresponding to each of the plurality of display operation modes. The display control module is further capable of providing a user interface capable of enabling selection of one of the plurality of display operation modes associated with an in-focus software application. The display control module is also capable of transmitting the values of display parameters corresponding to one of the plurality of display operation modes to the display.

In some implementations, the display control module is capable of providing the user interface capable of enabling selection of one of the plurality of display operation modes to apply specifically to the in-focus software application. In some implementations, the display module is implemented in computer readable instructions, and where the processor is further capable of executing the computer readable instructions implementing the display control module. In some implementations, the display parameters include at least one of: color gamut, bit depth, and frame rate. In some implementations, the display control module is capable of providing the user interface in response to input received via a persistent display operation mode settings input of the electronic device. In some implementations, the display control module is capable of providing the user interface in response to input received via a main settings menu of the electronic device.

In some implementations, the display control module is capable of providing a visual feedback of the effect of the selected one of the plurality of the display operation modes on a currently running application. In some implementations, the display control module is capable of providing a visual feedback of at least a portion of an image of the currently running software application modified by the selected one of the plurality of the display operation modes. In some implementations, the display control module is capable of providing a visual feedback of a generic image modified by the selected one of the plurality of the display operation modes.

In some implementations, the user interface is capable of enabling selection of one of the plurality of display operation modes for one of the plurality of software applications stored on the electronic device, and the display control module is capable of transmitting the values of the display parameters to the display when the one of the plurality of software applications stored on the electronic device is active.

In some implementations, the display control module is capable of maintaining an application data structure including a list of the plurality of software applications stored on the display device and the selected one of the plurality of display operation modes corresponding to the each of the plurality of software applications. In some implementations, the user interface is capable of enabling selection of one of the plurality of display operation modes as a global override display operation mode. In some implementations, the display control module is capable of transmitting the display parameters of the selected one of the plurality of display operation modes to the display for all software applications running on the electronic device.

Another innovative aspect of the subject matter described in this disclosure can be implemented in an electronic device, including a processor capable of executing a plurality of software applications on the electronic device, a display control module and a display. The display control module is capable of providing a user interface capable of enabling selection of one of the plurality of display operation modes associated with an in-focus software application, and transmitting the selected one of the plurality of display operation modes to a display. The display is capable of maintaining a display operation mode data structure including the plurality of display operation modes and the values of display parameters corresponding to each of the plurality of display operation modes. The display is further capable of receiving the selected one of the plurality of display operation modes from the display control module. The display is also capable of generating images according to the values of display parameters corresponding to the selected one of the plurality of display operation modes received from the display control module.

In some implementations, the display module is implemented in computer readable instructions, and where the processor is further capable of executing the computer readable instructions implementing the display control module. In some implementations, the user interface is capable of enabling selection of one of the plurality of display operation modes to apply specifically to the in-focus software application. In some implementations, the display parameters include at least one of: color gamut, bit depth, and frame rate. In some implementations, the display control module is capable of providing the user interface in response to input received via a persistent display operation mode settings input of the electronic device. In some implementations, the display control module is capable of providing the user interface in response to input received via a main settings menu of the electronic device.

In some implementations, the display module is capable of providing a visual feedback of the effect of the selected one of the plurality of the display operation modes on an image output by a currently running software application. In some implementations, the display module is capable of providing a visual feedback of at least a portion of an image output by the currently running software application modified by the selected one of the plurality of the display operation modes. In some implementations, the display module is capable of providing a visual feedback of a generic image modified by the selected on of the plurality of the display operation modes.

In some implementations, the user interface is capable of enabling selection of one of the plurality of display operation modes for one of the plurality of software applications stored on the electronic device, and the display control module is configured to transmit the selected one of the plurality of display operation modes to the display when the one of the plurality of software applications stored on the electronic device is active. In some implementations, the display control module is capable of maintaining an application data structure including a list of the plurality of software applications stored on the electronic device and the selected one of the plurality of display operation modes corresponding to the each of the plurality of software applications.

Another innovative aspect of the subject matter described in this disclosure can be implemented in a method for displaying an image on a display device. The method includes, maintaining a display operation mode data structure including a plurality of display operation modes and values of display parameters corresponding to each of the plurality of display operation modes. The method further includes providing a user interface capable of enabling selection of one of the plurality of display operation modes associated with an in-focus software application. The method also includes displaying an image by utilizing values of display parameters corresponding to the selected one of the plurality of display operation modes maintained in the display operation mode data structure.

In some implementations, providing a user interface capable of enabling selection of one of the plurality of display operation modes associated with an in-focus software application includes enabling selection of one of the plurality of display operation modes to apply specifically to the in-focus software application. In some implementations, maintaining a display operation mode data structure including a plurality of display operation modes and values of display parameters corresponding to each of the plurality of display operation modes includes maintaining the display operating mode data structure at a host device processor communicably connected to a display controller controlling the operation of an electronic display. In some implementations, providing a user interface capable of enabling selection of one of the plurality of display operation modes associated with an in-focus software application includes providing the user interface in response to input received via a persistent display operation mode settings input of the display device. In some implementations, providing a user interface capable of enabling selection of one of the plurality of display operation modes associated with an in-focus software application includes providing the user interface in response to input received via a main settings menu of the display device.

In some implementations, providing a user interface capable of enabling selection of one of the plurality of display operation modes associated with an in-focus software application includes providing a visual feedback of the effect of the selected one of the plurality of the display operation modes on a currently running application. In some implementations, providing a user interface capable of enabling selection of one of the plurality of display operation modes associated with an in-focus software application includes providing the user interface for selecting one of the plurality of display operation modes for one of a plurality of applications stored on the display device. In some implementations, the method further includes maintaining an application data structure including a list of the plurality of applications stored on the display device and the selected one of the plurality of display operation modes corresponding to the each of the plurality of applications.

Another innovative aspect of the subject matter described in this disclosure can be implemented in a non-transitory computer readable storage medium having instructions encoded thereon, which when executed by a processor cause the processor to perform a method for displaying an image on a display device. The method includes maintaining a display operation mode data structure including a plurality of display operation modes and values of display parameters corresponding to each of the plurality of display operation modes. The method further includes providing a user interface capable of enabling selection of one of the plurality of display operation modes associated with an in-focus software application. The method also includes displaying an image by utilizing values of display parameters corresponding to the selected one of the plurality of display operation modes maintained in the display operation mode data structure.

In some implementations, the providing a user interface capable of enabling selection of one of the plurality of display operation modes associated with an in-focus software application includes providing the user interface capable of enabling selection of one of the plurality of display operation modes to apply specifically to the in-focus software application. In some implementations, providing a user interface capable of enabling selection of one of the plurality of display operation modes associated with an in-focus software application includes providing the user interface in response to input received via a persistent display operation mode settings input of the display device.

In some implementations, providing a user interface capable of enabling selection of one of the plurality of display operation modes associated with an in-focus software application includes providing a visual feedback of the effect of the selected one of the plurality of the display operation modes on a currently running application. In some implementations, the method further includes maintaining an application data structure including a list of the plurality of applications stored on the display device and the selected one of the plurality of display operation modes corresponding to the each of the plurality of applications.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1A shows a schematic diagram of an example direct-view microelectromechanical systems (MEMS) based display apparatus.

FIG. 1B shows a block diagram of an example host device.

FIGS. 2A and 2B show views of an example dual actuator shutter assembly.

FIG. 3 shows a block diagram of an example display module parameter selection system.

FIGS. 4A-4E show various example screenshots of user interfaces for adjusting display operation modes of a display device.

FIGS. 5A-5D show various example screenshots of user interfaces for adjusting display operation modes from a main settings menu of display device.

FIGS. 6A-6D show various example data structures that can be utilized by a display device for display operation mode selection.

FIG. 7 shows an example flow diagram of a process for displaying an image on an electronic display shown in FIG. 3.

FIGS. 8A and 8B show system block diagrams illustrating an example display device that includes a plurality of display elements

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that is capable of displaying an image, whether in motion (such as video) or stationary (such as still images), and whether textual, graphical or pictorial. The concepts and examples provided in this disclosure may be applicable to a variety of displays, such as liquid crystal displays (LCDs), organic light-emitting diode (OLED) displays, field emission displays, and electromechanical systems (EMS) and microelectromechanical (MEMS)-based displays, in addition to displays incorporating features from one or more display technologies.

The described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, wearable devices, clocks, calculators, television monitors, flat panel displays, electronic reading devices (such as e-readers), computer monitors, auto displays (such as odometer and speedometer displays), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, in addition to non-EMS applications), aesthetic structures (such as display of images on a piece of jewelry or clothing) and a variety of EMS devices.

The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

In some implementations, display devices can utilize selectable display operation modes for displaying content. Various display parameter values such as frame rate, color bit depth, maximum brightness level, color gamut, percentages of color gamut, white point, gamma, and the number of subframes or bit-planes per image frame, can be utilized for automatically determining appropriate or optimal display operation modes for the content displayed on the display device. In some implementations, the display operation modes can be presented, for example, to a user, for selection using a user interface. The user interface can be capable of providing the ability to select global display operation modes for all applications running on the display device. In some implementations, the user interface can allow the assignment of display operation modes to individual applications.

In some implementations, the user interface can allow the assignment of display operation modes specifically for an in-focus application. In some implementations, the display device may provide the output of a single application to the user at a given time, even though the display device may have multiple applications running in the background. For example, some tablet computers and smartphones may display the output of a single application that is active to the user at a given time. In some such implementations, an in-focus application can refer to an application that is currently active and an output of which is being currently displayed to the user. In some other implementations, the display device may provide the user with the outputs of multiple applications currently running on the display device. For example, some computers, tablet computers, smartphones, or wearable devices may display the output of multiple applications that are currently running on the device. In some implementations, the output may be displayed in separate application windows. In such implementations, an in-focus application refers to an application that is currently running and with which the user is currently interacting, for example in a currently selected and active application window. The display operation modes selected by the user can be stored in memory. In some implementations, the display device can display an in-focus application using previously stored display mode operation modes associated with the in-focus application. In some implementations, the user interface can be launched by user input on the display device. In some implementations, the user can access the user interface via a settings menu of the display device. In some implementations, the user interface can provide a preview of the effect of the display operation mode selected by the user.

In some implementations, the display device can maintain several data structures to store the display operation modes selected by the user. The data structures can include identities of applications stored on the display device and, if selected by the user, corresponding display operation modes to be used when the respective applications are active. In some implementations, the display device can apply display operation modes selected for one application of a group of applications to all applications in that group of applications. For example, a display operation mode selected by a user for one in-focus email application can be stored in the data structure as display operation modes corresponding to the identities of all email applications stored in the display device. As a result, when the user activates another email application, that email application also would be displayed using the same display operation mode. Other examples, of groups of application to which the display device can apply common display operation modes can include, without limitation, web browser applications, e-reader applications, navigation applications, video-chat applications, movie applications, etc. In some implementations, the data structures can include values of display parameters, such as frame rate, bit depth, brightness, and color gamut associated with each display operation mode.

Particular implementations of the subject matter described in this disclosure can be implemented to realize one or more of the following potential advantages. A display device provides a wide range of operations from offering a fully automatic to offering user customizable selection of display operation modes for displaying content on the display device. With automatic selection of display operation mode, the display device automatically selects a display operation mode based, at least, on the content or applications being currently displayed, without burdening the user with display operation mode selection. The display device also offers flexibility and customization to the user by allowing the user to select the desired display operation mode via a display operation mode user interface. The display operation mode user interface can allow the user to select global display operation modes, and also allow the user to select display operation modes specific to individual applications. The display operation mode user interface also can allow the user to view and modify display operation modes for an in-focus application. A persistent user input, such as a push-button, touch-sensitive button and touch-screen interface on the display device, provides the user convenient access to the display operation mode user interface. By allowing the user to modify and create display operation modes, the user interface allows the user to customize the display of content on the display device, and in some implementations, manage the display's consumption of power.

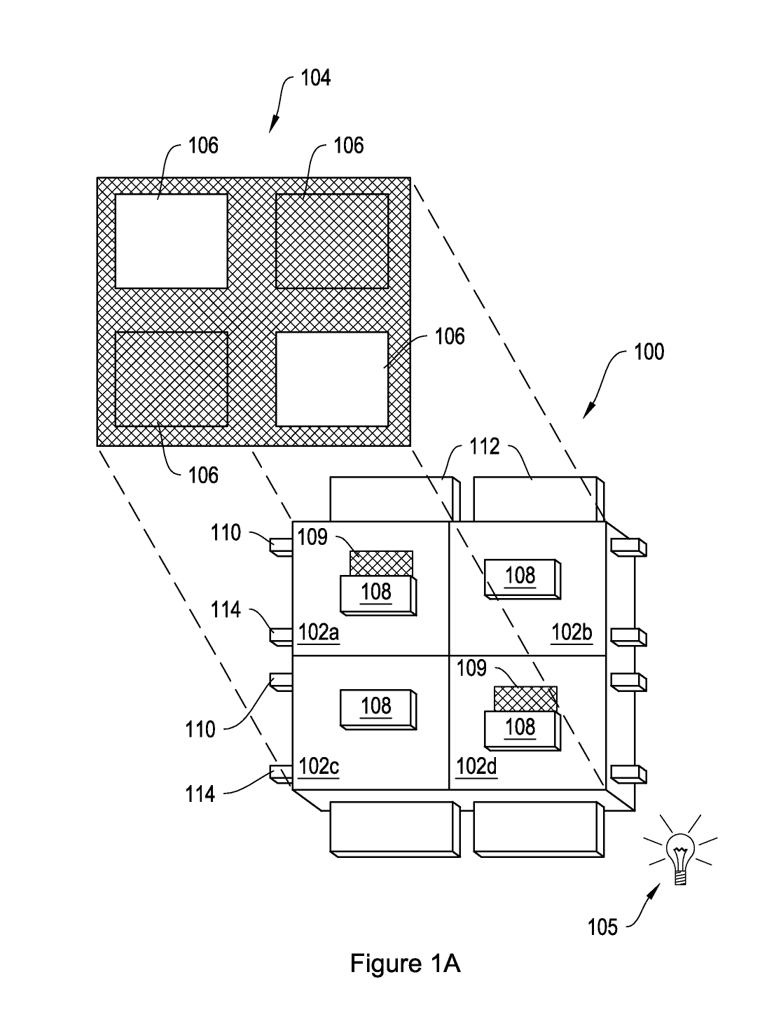

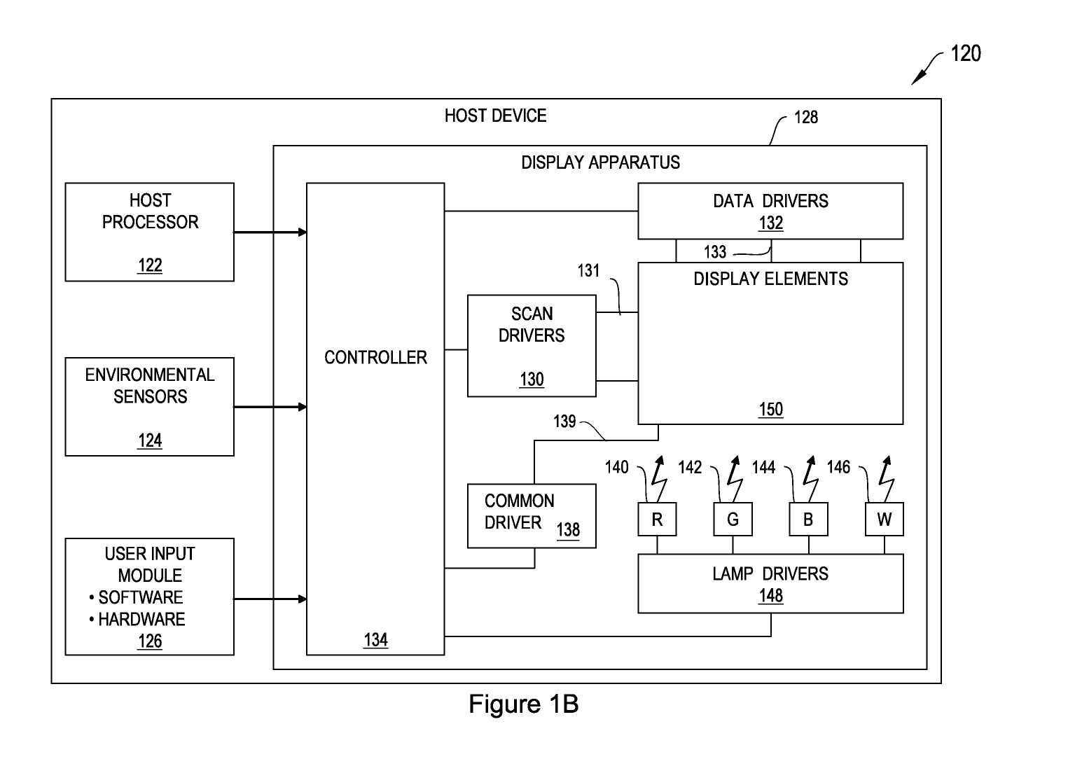

FIG. 1A shows a schematic diagram of an example direct-view MEMS-based display apparatus 100. The display apparatus 100 includes a plurality of light modulators 102a-102d (generally light modulators 102) arranged in rows and columns. In the display apparatus 100, the light modulators 102a and 102d are in the open state, allowing light to pass. The light modulators 102b and 102c are in the closed state, obstructing the passage of light. By selectively setting the states of the light modulators 102a-102d, the display apparatus 100 can be utilized to form an image 104 for a backlit display, if illuminated by a lamp or lamps 105. In another implementation, the apparatus 100 may form an image by reflection of ambient light originating from the front of the apparatus. In another implementation, the apparatus 100 may form an image by reflection of light from a lamp or lamps positioned in the front of the display, i.e., by use of a front light.

In some implementations, each light modulator 102 corresponds to a pixel 106 in the image 104. In some other implementations, the display apparatus 100 may utilize a plurality of light modulators to form a pixel 106 in the image 104. For example, the display apparatus 100 may include three color-specific light modulators 102. By selectively opening one or more of the color-specific light modulators 102 corresponding to a particular pixel 106, the display apparatus 100 can generate a color pixel 106 in the image 104. In another example, the display apparatus 100 includes two or more light modulators 102 per pixel 106 to provide a luminance level in an image 104. With respect to an image, a pixel corresponds to the smallest picture element defined by the resolution of image. With respect to structural components of the display apparatus 100, the term pixel refers to the combined mechanical and electrical components utilized to modulate the light that forms a single pixel of the image.

The display apparatus 100 is a direct-view display in that it may not include imaging optics typically found in projection applications. In a projection display, the image formed on the surface of the display apparatus is projected onto a screen or onto a wall. The display apparatus is substantially smaller than the projected image. In a direct view display, the image can be seen by looking directly at the display apparatus, which contains the light modulators and optionally a backlight or front light for enhancing brightness and/or contrast seen on the display.

Direct-view displays may operate in either a transmissive or reflective mode. In a transmissive display, the light modulators filter or selectively block light which originates from a lamp or lamps positioned behind the display. The light from the lamps is optionally injected into a lightguide or backlight so that each pixel can be uniformly illuminated. Transmissive direct-view displays are often built onto transparent substrates to facilitate a sandwich assembly arrangement where one substrate, containing the light modulators, is positioned over the backlight. In some implementations, the transparent substrate can be a glass substrate (sometimes referred to as a glass plate or panel), or a plastic substrate. The glass substrate may be or include, for example, a borosilicate glass, wine glass, fused silica, a soda lime glass, quartz, artificial quartz, Pyrex, or other suitable glass material.

Each light modulator 102 can include a shutter 108 and an aperture 109. To illuminate a pixel 106 in the image 104, the shutter 108 is positioned such that it allows light to pass through the aperture 109. To keep a pixel 106 unlit, the shutter 108 is positioned such that it obstructs the passage of light through the aperture 109. The aperture 109 is defined by an opening patterned through a reflective or light-absorbing material in each light modulator 102.

The display apparatus also includes a control matrix coupled to the substrate and to the light modulators for controlling the movement of the shutters. The control matrix includes a series of electrical interconnects (such as interconnects 110, 112 and 114), including at least one write-enable interconnect 110 (also referred to as a scan line interconnect) per row of pixels, one data interconnect 112 for each column of pixels, and one common interconnect 114 providing a common voltage to all pixels, or at least to pixels from both multiple columns and multiples rows in the display apparatus 100. In response to the application of an appropriate voltage (the write-enabling voltage, V_{WE}), the write-enable interconnect 110 for a given row of pixels prepares the pixels in the row to accept new shutter movement instructions. The data interconnects 112 communicate the new movement instructions in the form of data voltage pulses. The data voltage pulses applied to the data interconnects 112, in some implementations, directly contribute to an electrostatic movement of the shutters. In some other implementations, the data voltage pulses control switches, such as transistors or other non-linear circuit elements that control the application of separate drive voltages, which are typically higher in magnitude than the data voltages, to the light modulators 102. The application of these drive voltages results in the electrostatic driven movement of the shutters 108.

The control matrix also may include, without limitation, circuitry, such as a transistor and a capacitor associated with each shutter assembly. In some implementations, the gate of each transistor can be electrically connected to a scan line interconnect. In some implementations, the source of each transistor can be electrically connected to a corresponding data interconnect. In some implementations, the drain of each transistor may be electrically connected in parallel to an electrode of a corresponding capacitor and to an electrode of a corresponding actuator. In some implementations, the other electrode of the capacitor and the actuator associated with each shutter assembly may be connected to a common or ground potential. In some other implementations, the transistor can be replaced with a semiconducting diode, or a metal-insulator-metal switching element.

FIG. 1B shows a block diagram of an example host device 120 (i.e., cell phone, smart phone, PDA, MP3 player, tablet, e-reader, netbook, notebook, watch, wearable device, laptop, television, or other electronic device). The host device 120 includes a display apparatus 128 (such as the display apparatus 100 shown in FIG. 1A), a host processor 122, environmental sensors 124, a user input module 126, and a power source.

The display apparatus 128 includes a plurality of scan drivers 130 (also referred to as write-enabling voltage sources), a plurality of data drivers 132 (also referred to as data voltage sources), a controller 134, common drivers 138, lamps 140-146, lamp drivers 148 and an array of display elements 150, such as the light modulators 102 shown in FIG. 1A. The scan drivers 130 apply write-enabling voltages to scan line interconnects 131. The data drivers 132 apply data voltages to the data interconnects 133.

In some implementations of the display apparatus, the data drivers 132 are capable of providing analog data voltages to the array of display elements 150, especially where the luminance level of the image is to be derived in analog fashion. In analog operation, the display elements are designed such that when a range of intermediate voltages is applied through the data interconnects 133, there results a range of intermediate illumination states or luminance levels in the resulting image. In some other implementations, the data drivers 132 are capable of applying a reduced set, such as 2, 3 or 4, of digital voltage levels to the data interconnects 133. In implementations in which the display elements are shutter-based light modulators, such as the light modulators 102 shown in FIG. 1A, these voltage levels are designed to set, in digital fashion, an open state, a closed state, or other discrete state to each of the shutters 108. In some implementations, the drivers are capable of switching between analog and digital modes.

The scan drivers 130 and the data drivers 132 are connected to a digital controller circuit 134 (also referred to as the controller 134). The controller 134 sends data to the data drivers 132 in a mostly serial fashion, organized in sequences, which in some implementations may be predetermined, grouped by rows and by image frames. The data drivers 132 can include series-to-parallel data converters, level-shifting, and for some applications digital-to-analog voltage converters.

The display apparatus optionally includes a set of common drivers 138, also referred to as common voltage sources. In some implementations, the common drivers 138 provide a DC common potential to all display elements within the array 150 of display elements, for instance by supplying voltage to a series of common interconnects 139. In some other implementations, the common drivers 138, following commands from the controller 134, issue voltage pulses or signals to the array of display elements 150, for instance global actuation pulses which are capable of driving and/or initiating simultaneous actuation of all display elements in multiple rows and columns of the array.

Each of the drivers (such as scan drivers 130, data drivers 132 and common drivers 138) for different display functions can be time-synchronized by the controller 134. Timing commands from the controller 134 coordinate the illumination of red, green, blue and white lamps (140, 142, 144 and 146 respectively) via lamp drivers 148, the write-enabling and sequencing of specific rows within the array of display elements 150, the output of voltages from the data drivers 132, and the output of voltages that provide for display element actuation. In some implementations, the lamps are light emitting diodes (LEDs).

The controller 134 determines the sequencing or addressing scheme by which each of the display elements can be re-set to the illumination levels appropriate to a new image 104. New images 104 can be set at periodic intervals. For instance, for video displays, color images or frames of video are refreshed at frequencies ranging from 10 to 300 Hertz (Hz). In some implementations, the setting of an image frame to the array of display elements 150 is synchronized with the illumination of the lamps 140, 142, 144 and 146 such that alternate image frames are illuminated with an alternating series of colors, such as red, green, blue and white. The image frames for each respective color are referred to as color subframes. In this method, referred to as the field sequential color method, if the color subframes are alternated at frequencies in excess of 20 Hz, the human visual system (HVS) will average the alternating frame images into the perception of an image having a broad and continuous range of colors. In some other implementations, the lamps can employ primary colors other than red, green, blue and white. In some implementations, fewer than four, or more than four lamps with primary colors can be employed in the display apparatus 128.

In some implementations, where the display apparatus 128 is designed for the digital switching of shutters, such as the shutters 108 shown in FIG. 1A, between open and closed states, the controller 134 forms an image by the method of time division gray scale. In some other implementations, the display apparatus 128 can provide gray scale through the use of multiple display elements per pixel.

In some implementations, the data for an image state is loaded by the controller 134 to the array of display elements 150 by a sequential addressing of individual rows, also referred to as scan lines. For each row or scan line in the sequence, the scan driver 130 applies a write-enable voltage to the write enable interconnect 131 for that row of the array of display elements 150, and subsequently the data driver 132 supplies data voltages, corresponding to desired shutter states, for each column in the selected row of the array. This addressing process can repeat until data has been loaded for all rows in the array of display elements 150. In some implementations, the sequence of selected rows for data loading is linear, proceeding from top to bottom in the array of display elements 150. In some other implementations, the sequence of selected rows is pseudo-randomized, in order to mitigate potential visual artifacts. And in some other implementations, the sequencing is organized by blocks, where, for a block, the data for a certain fraction of the image is loaded to the array of display elements 150. For example, the sequence can be implemented to address every fifth row of the array of the display elements 150 in sequence.

In some implementations, the addressing process for loading image data to the array of display elements 150 is separated in time from the process of actuating the display elements. In such an implementation, the array of display elements 150 may include data memory elements for each display element, and the control matrix may include a global actuation interconnect for carrying trigger signals, from the common driver 138, to initiate simultaneous actuation of the display elements according to data stored in the memory elements.

In some implementations, the array of display elements 150 and the control matrix that controls the display elements may be arranged in configurations other than rectangular rows and columns. For example, the display elements can be arranged in hexagonal arrays or curvilinear rows and columns.

The host processor 122 generally controls the operations of the host device 120. For example, the host processor 122 may be a general or special purpose processor for controlling a portable electronic device. With respect to the display apparatus 128, included within the host device 120, the host processor 122 outputs image data as well as additional data about the host device 120. Such information may include data from environmental sensors 124, such as ambient light or temperature; information about the host device 120, including, for example, an operating mode of the host or the amount of power remaining in the host device's power source; information about the content of the image data; information about the type of image data; and/or instructions for the display apparatus 128 for use in selecting an imaging mode.

In some implementations, the user input module 126 enables the conveyance of personal preferences of a user to the controller 134, either directly, or via the host processor 122. In some implementations, the user input module 126 is controlled by software in which a user inputs personal preferences, for example, color, contrast, power, brightness, content, and other display settings and parameters preferences. In some other implementations, the user input module 126 is controlled by hardware in which a user inputs personal preferences. In some implementations, the user may input these preferences via voice commands, one or more buttons, switches or dials, or with touch-capability. The plurality of data inputs to the controller 134 direct the controller to provide data to the various drivers 130, 132, 138 and 148 which correspond to optimal imaging characteristics.

The environmental sensor module 124 also can be included as part of the host device 120. The environmental sensor module 124 can be capable of receiving data about the ambient environment, such as temperature and or ambient lighting conditions. The sensor module 124 can be programmed, for example, to distinguish whether the device is operating in an indoor or office environment versus an outdoor environment in bright daylight versus an outdoor environment at nighttime. The sensor module 124 communicates this information to the display controller 134, so that the controller 134 can optimize the viewing conditions in response to the ambient environment.

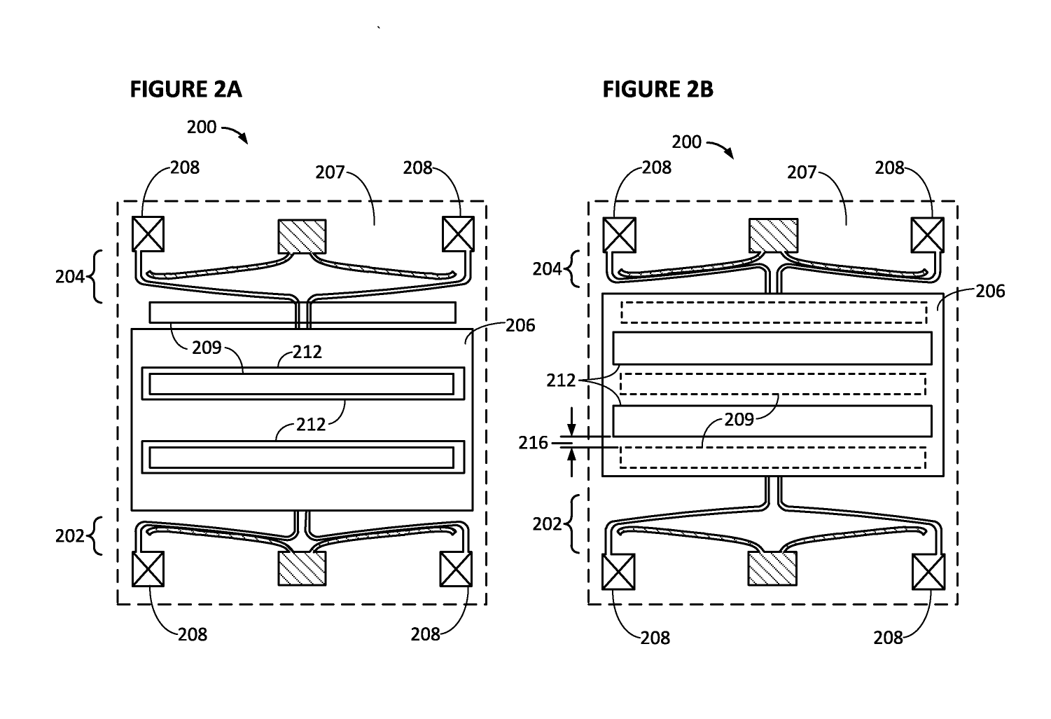

FIGS. 2A and 2B show views of an example dual actuator shutter assembly 200. The dual actuator shutter assembly 200, as depicted in FIG. 2A, is in an open state. FIG. 2B shows the dual actuator shutter assembly 200 in a closed state. The shutter assembly 200 includes actuators 202 and 204 on either side of a shutter 206. Each actuator 202 and 204 is independently controlled. A first actuator, a shutter-open actuator 202, serves to open the shutter 206. A second opposing actuator, the shutter-close actuator 204, serves to close the shutter 206. Each of the actuators 202 and 204 can be implemented as compliant beam electrode actuators. The actuators 202 and 204 open and close the shutter 206 by driving the shutter 206 substantially in a plane parallel to an aperture layer 207 over which the shutter is suspended. The shutter 206 is suspended a short distance over the aperture layer 207 by anchors 208 attached to the actuators 202 and 204. Having the actuators 202 and 204 attach to opposing ends of the shutter 206 along its axis of movement reduces out of plane motion of the shutter 206 and confines the motion substantially to a plane parallel to the substrate (not depicted).

In the depicted implementation, the shutter 206 includes two shutter apertures 212 through which light can pass. The aperture layer 207 includes a set of three apertures 209. In FIG. 2A, the shutter assembly 200 is in the open state and, as such, the shutter-open actuator 202 has been actuated, the shutter-close actuator 204 is in its relaxed position, and the centerlines of the shutter apertures 212 coincide with the centerlines of two of the aperture layer apertures 209. In FIG. 2B, the shutter assembly 200 has been moved to the closed state and, as such, the shutter-open actuator 202 is in its relaxed position, the shutter-close actuator 204 has been actuated, and the light blocking portions of the shutter 206 are now in position to block transmission of light through the apertures 209 (depicted as dotted lines).

Each aperture has at least one edge around its periphery. For example, the rectangular apertures 209 have four edges. In some implementations, in which circular, elliptical, oval, or other curved apertures are formed in the aperture layer 207, each aperture may have a single edge. In some other implementations, the apertures need not be separated or disjointed in the mathematical sense, but instead can be connected. That is to say, while portions or shaped sections of the aperture may maintain a correspondence to each shutter, several of these sections may be connected such that a single continuous perimeter of the aperture is shared by multiple shutters.

In order to allow light with a variety of exit angles to pass through the apertures 212 and 209 in the open state, the width or size of the shutter apertures 212 can be designed to be larger than a corresponding width or size of apertures 209 in the aperture layer 207. In order to effectively block light from escaping in the closed state, the light blocking portions of the shutter 206 can be designed to overlap the edges of the apertures 209. FIG. 2B shows an overlap 216, which in some implementations can be predefined, between the edge of light blocking portions in the shutter 206 and one edge of the aperture 209 formed in the aperture layer 207.

The electrostatic actuators 202 and 204 are designed so that their voltage-displacement behavior provides a bi-stable characteristic to the shutter assembly 200. For each of the shutter-open and shutter-close actuators, there exists a range of voltages below the actuation voltage, which if applied while that actuator is in the closed state (with the shutter being either open or closed), will hold the actuator closed and the shutter in position, even after a drive voltage is applied to the opposing actuator. The minimum voltage needed to maintain a shutter's position against such an opposing force is referred to as a maintenance voltage Vₘ.

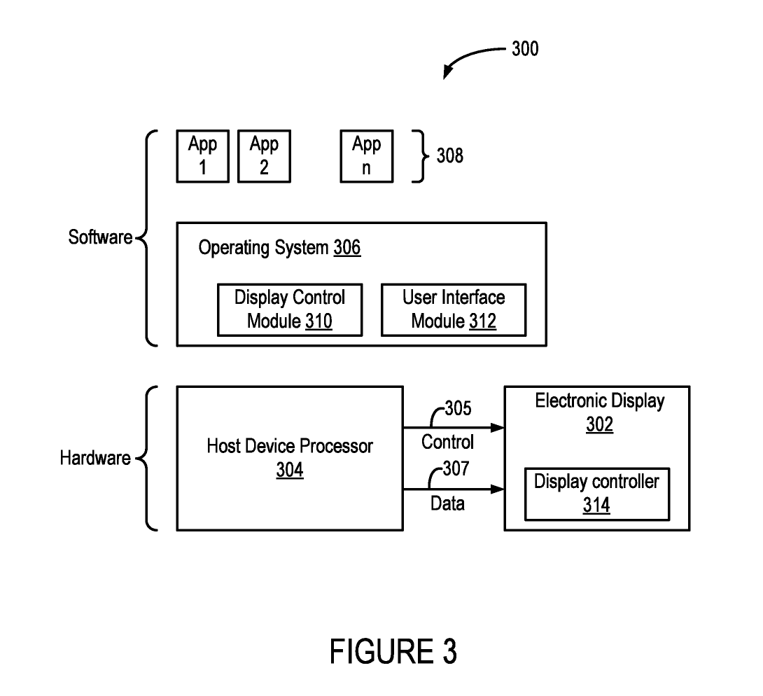

FIG. 3 shows a block diagram of an example display module parameter selection system 300. The display module parameter selection system 300 can be incorporated into an electronic device, such as the host device 120 depicted in FIG. 1B. The system 300 includes an electronic display 302 communicatively coupled to a host device processor 304. The system 300 also includes software components such as an operating system 306, a plurality of applications 308, and a display control module 310.

The electronic display 302 may be any of a variety of displays, including a digital or analog display. For example, the electronic display 302 can be or can include a flat-panel display, such as plasma, EMS, electroluminescent (EL) displays, OLED, super twisted nematic (STN) display, LCD, or thin-film transistor (TFT) LCD, or a non-flat-panel display. In addition, the electronic display 302 can include a mechanical light modulator-based display.

The electronic display 302 can be controlled by the host device processor 304. A variety of display settings used by the electronic display 302 may be adjusted by the host device processor 304. For example, the electronic display 302 can operate using various combinations of display parameters such as frame rates, color bit depths, maximum brightness levels, color gamuts, percentages of a color gamut, white points, gammas, and the number of subframes or bit-planes per image frame. Other display parameters of the electronic display 302 also may be adjustable. The display parameters can be adjusted by a display controller 314 (such as the controller 134 shown in FIG. 1B) within the electronic display 302 by adjusting the output sequence it uses to output subframes to an array of display elements (such as the light modulators 150, also shown in FIG. 1B). The display controller 314 also can adjust the intensities with which it illuminates light sources within the electronic display 302. The selection of a particular value for each display parameter to be applied to the electronic display 302 can be determined by the host device processor 304.

In some implementations, the electronic display 302 can be controlled by the display controller 314. The display controller 314, in addition to adjusting the intensities of the light sources and the output sequence, also can adjust the display parameters such as frame rate, color bit depths, maximum brightness levels, color gamut, percentages of color gamut, white points, gammas and the number of subframes of bit-planes per image frame. In some such implementations, the host device processor 304 can provide the display controller 314 with image data that is to be displayed on the electronic display 302. In some implementations, the host device processor 304 can provide the display controller 314 with values of the display parameters with which to display the image data. In some implementations, the host device processor 304 may provide user selected display operation modes or the identity of the in-focus application (discussed further below) along with the image data. The display controller 314 can in turn maintain in memory values for various display parameters corresponding to various display operation modes, and use the values corresponding to the user selected display mode received from the host device processor 304 for displaying image data on the electronic display 302.

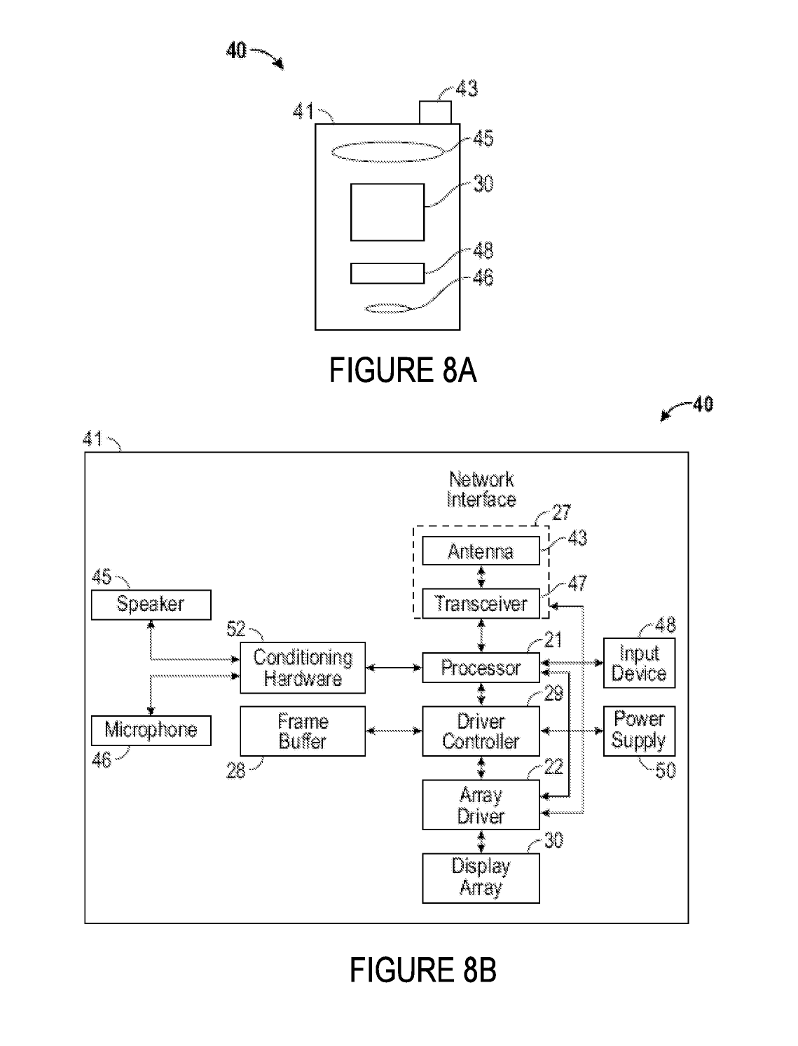

The host device processor 304 may be any type of electronic processor capable of controlling the electronic display 302. For example, the host device processor 304 can be implemented using the processor 21 discussed below in relation to FIG. 8B, and can include one or more general purpose processors, digital signal processors, graphics processors, etc. The host device processor 304 can be capable of executing computer instructions and communicating with the electronic display 302 to control the output characteristics of the electronic display 302. Control information 305, such as information corresponding to the desired output characteristics of the electronic display 302 can be transmitted from the host device processor 304 to the electronic display 302. Other data 307, such as the image data to be displayed, also can be transmitted from the host device processor 304 to the electronic display 302.

The software components of the system 300, such as an operating system 306, applications 308, and the display control module 310 can be executed by the host device processor 304. For example, the operating system 306 can be a commercially available computer operating system executing on a personal computer, such as the WINDOWS™ operating system produced by Microsoft Corporation of Redmond, Wash. or the OS X™ operating system produced by Apple Inc. of Cupertino, Calif. In some other implementations, the operating system 306 can be an operating system suitable for use in mobile computing devices, such as the IOS™ operating system produced by Apple Inc. or the ANDROID™ operating system produced by Google Inc. of Mountain View, Calif. The operating system 306 can execute on computer hardware, such as the host device processor 304, and can allocate resources and provide services to any of the plurality of applications 308. In some implementations, the operating system 306 also includes a user interface module 312, also known as a user interface module, for receiving input. For example, the user interface module 312 can receive input via push-buttons, touch-sensitive buttons, switches, etc., located on the electronic display 302. In some implementations, the user interface module 312 can include a voice recognition module to receive voice commands. The user interface module 312 can communicate the input received to one or more modules within the system 300, for example to the operating system 306, the display control module 310, the host device processor 304, etc.

The applications 308 are computer programs executable by the host device processor 304. For example, the applications 308 can be installed on the computing device controlled by the host device processor 304. One of the applications 308 can be launched in response to a request, for example, by a user of the computing device. Each of the applications 308 can allow the user to interact with the inputs and/or outputs, such as the output of the electronic display 302, of the computing device in a particular fashion. For example, one of the applications 308 can provide a web browser interface to allow a user to view web pages, while another one of the applications 308 might provide video and image editing capabilities. Other examples of the applications 308 can include E-readers, email clients, games, text editors, file browsers, drawing programs, video and audio players, or any other type of computer program.

In some implementations, one or more of the applications 308 may be preinstalled on a computing device when the device is purchased by a customer. In some other implementations, the applications 308 may be installed subsequent to the purchase of the computing device. For example, applications 308 may be downloaded from third party application developers to the computing device via a computer network, such as the Internet. The downloaded applications can then be installed on the computing device. Applications 308 also may be developed independently by a user of the computing device. For example, the computing device itself can be used to develop an application, and the application can then be installed on the computing device.

There may be any number of applications 308 installed on a computing device, and each application 308 may have different display output requirements. For example, a graphics-intensive application 308, such as a three dimensional video game, may require a higher frame rate in order to provide the best possible experience for a user of the computing device. In this example, a refresh rate of about 120 Hz may be optimal. Such an application may be unusable at a relatively low frame rate, such as approximately 15 Hz. Other applications 308 may still perform acceptably at significantly lower frame rates. For example, an application having relatively little graphical content, such as an E-reader or text editor, may be considered as performing substantially the same at a frame rate of about 15 Hz as at a much higher frame rate, such as a frame rate of approximately 120 Hz. Other applications 308 may have varying requirements for other display output parameters. For example, a photo editing application may require a large bit depth, while an email client may not. There also may be applications 308 executed by host device processor 304 that have no visual content, and therefore have no graphical display output requirements.

In some implementations, some or all of the applications 308 can be installed and executed on a remote computer rather than on the host device processor 304. For example, an application 308 may be a virtual application executed on by a separate processor but displayed on the electronic display 302. In this example, host device processor 304 does not execute the application 308, but still transmits image data from the application 308 to the electronic display 302. It is therefore important for the host device processor 304 to properly control the electronic display 302 to display graphical content for applications that may not be executed by the host device processor 304.

Applications 308 can be launched in response to a command from the system 300. In some implementations, a user may wish to launch several of the applications 308 and execute the applications 308 simultaneously. For example, each application launched may be displayed in its own window on the electronic display 302. The window can occupy a portion of a display area or the entire display area of the electronic display 302. The concurrently executing applications each can have different display output preferences or requirements. In this example, the host device processor 304 can transmit the image data for all of the concurrently executing applications to the electronic display 302. The host device processor 304 also can control the electronic display 302 to operate with output characteristics that are suitable for displaying all of the applications 308 simultaneously.

The aforementioned output characteristics can be determined by a display control module 310 resident within the operating system 306 executing on the host device processor 304. The display control module 310 can communicate with the applications 308, the operating system 306, and the host device processor 304. For example, the display control module 310 can maintain information such as the display requirements of each application 308, as well as information indicating which, if any, of the applications 308 are currently executing on the host device processor 304. The display control module 310 can use information from the applications 308 to determine desired display output parameters for the electronic display 302, and can then cause the host device processor 304 to transmit (or communicate) the desired parameters to the electronic display 302.

The display control module 310 also can determine when it is desirable to alter the current display parameters of the electronic display 302. For example, the display control module 310 can continuously or periodically receive information about the applications 308 that are currently being executed by the processor 304. If an application 308 requiring a high frame rate is terminated, the display control module 310 can respond by transmitting to the host device processor 304 instructions to operate at a lower frame rate. The display control module 310 also can use other information to determine the desired operating parameters for the electronic display 302. For example, the display control module 310 can determine that reducing power consumption of the system 300 is a priority, and can respond by transmitting display parameter information to the host device processor 304 that will allow the system 300 to consume less power while displaying graphical content from the applications 308, such as a lower frame rate or reduced maximum brightness levels In some implementations, the display control module 310 can maintain a threshold frame rate, which can be the lowest frame rate at which content may be displayed. In some implementations, the display control module 310 can ensure that the frame rate does not go below the threshold frame rate. In cases where a user may select a frame rate below the threshold frame rate, the display control module 310 can override the selected frame rate by utilizing a frame rate that is at or above the threshold frame rate.

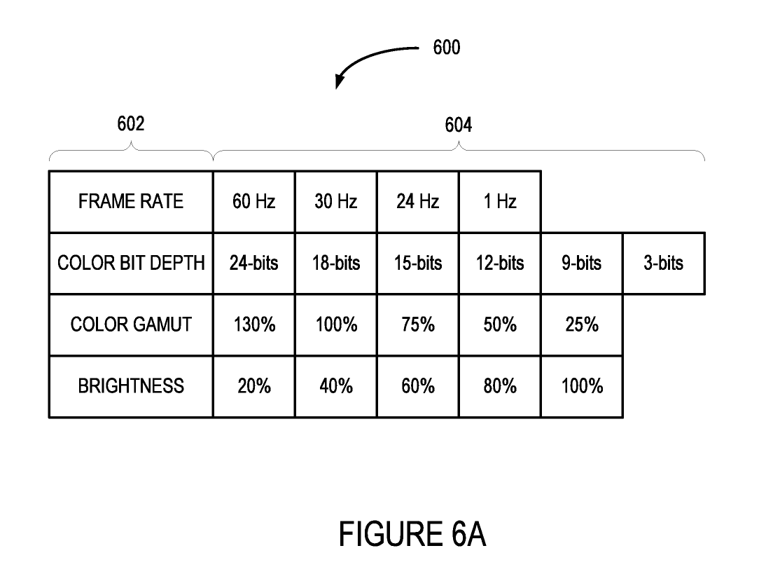

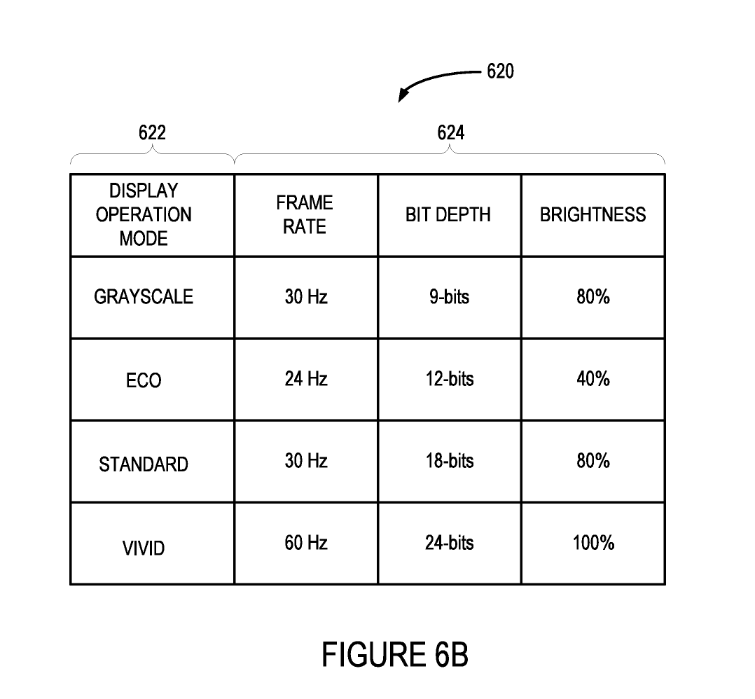

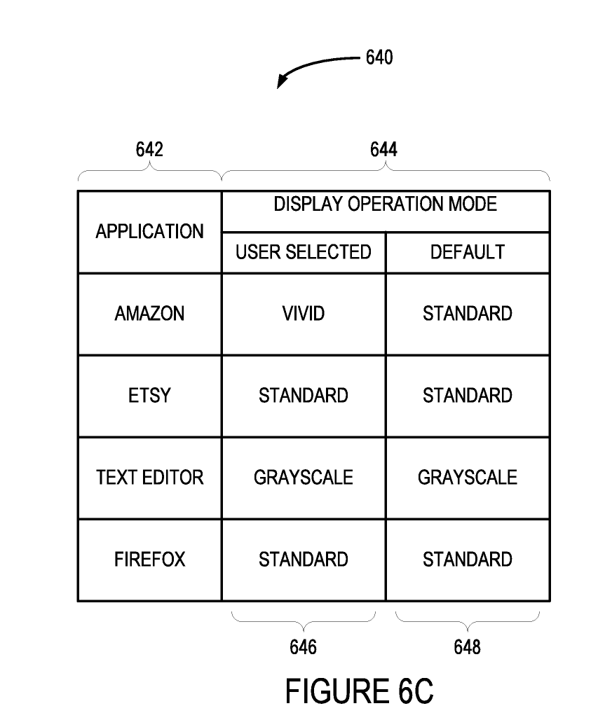

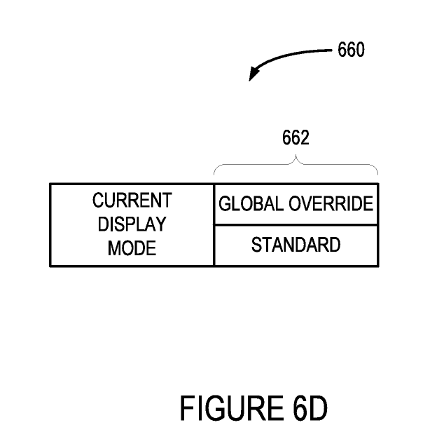

As mentioned above, the display control module 310 can continuously or periodically receive information about the applications 308 being currently executed. In some implementations, the display control module 310 can, without any user intervention or input, automatically determine the display operation mode or display parameters appropriate for displaying the application. In some implementations, the display control module 310 can take into account factors such as available battery charge, ambient light level, and temperature, to automatically adjust the values of the display parameters to display the application. In some implementations, desired or preferred values of various display parameters for different types of application content (such as text, video, etc.) under various levels of battery charge, ambient light, and temperature can be experimentally determined. The preferred values can be stored in look-up-tables or other data structures (similar to those discussed below in relation to FIGS. 6A-6D) for access by the display control module 310. In some implementations, preferred values of display parameters for each application can be stored in the display device as a preferred display operation mode for that application. When an application is active on the display screen, the display control module 310 can examine the content displayed by the application. Based on the content, the display control module 310 can access the look-up-tables or data structures stored in the display device to automatically select the preferred display operation mode. In some implementations, the content can be displayed using the selected display operation mode. In some implementations, the preferred display operation mode can be presented to the user on a user interface. The user may then choose to display the content using the preferred display operation mode determined by the display control module 310 or choose to display the content based on user selected display operation modes.

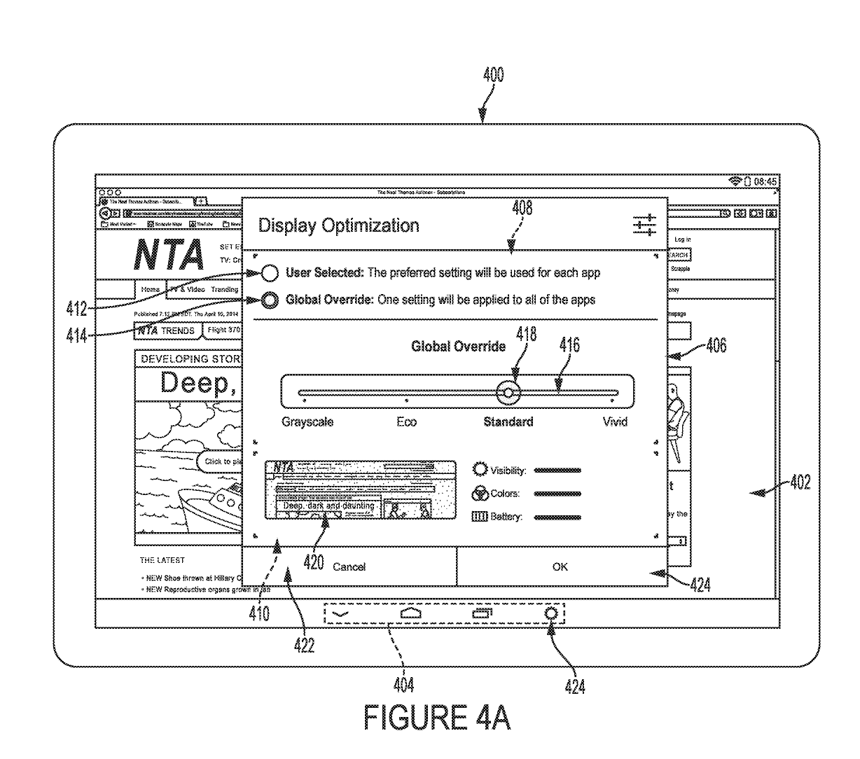

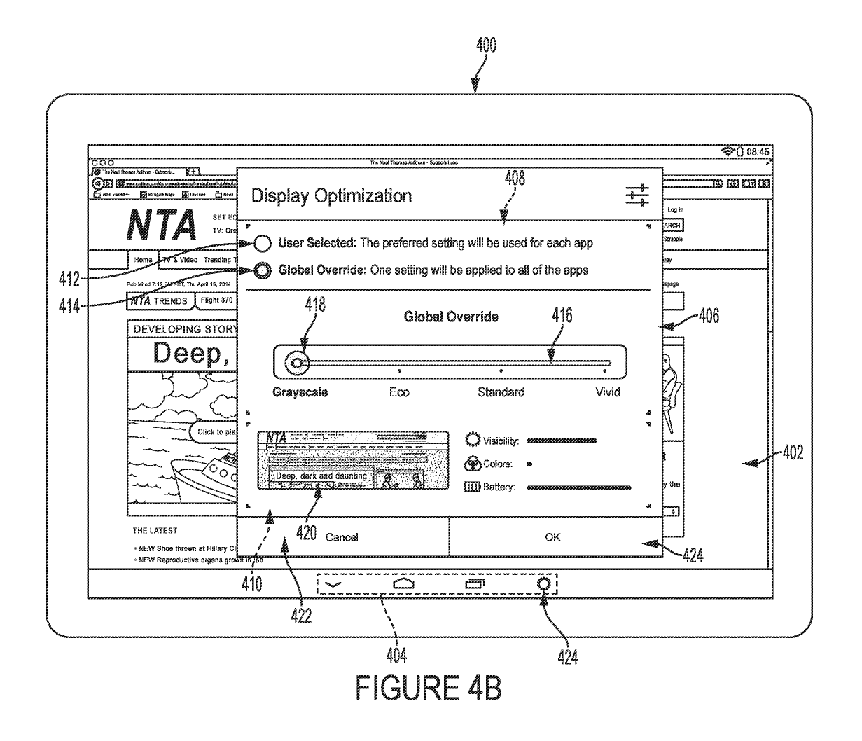

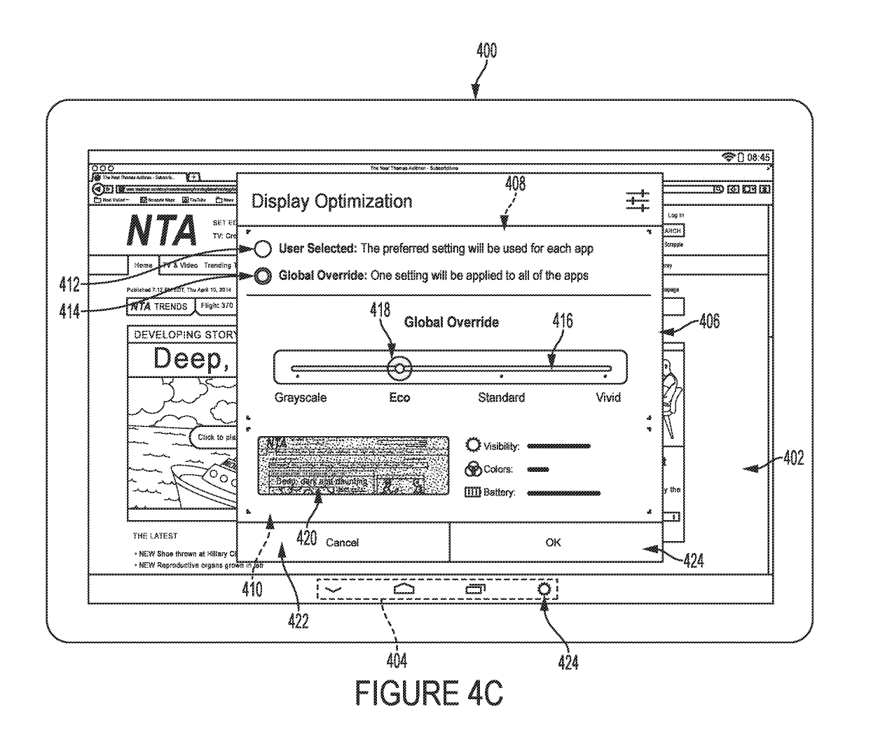

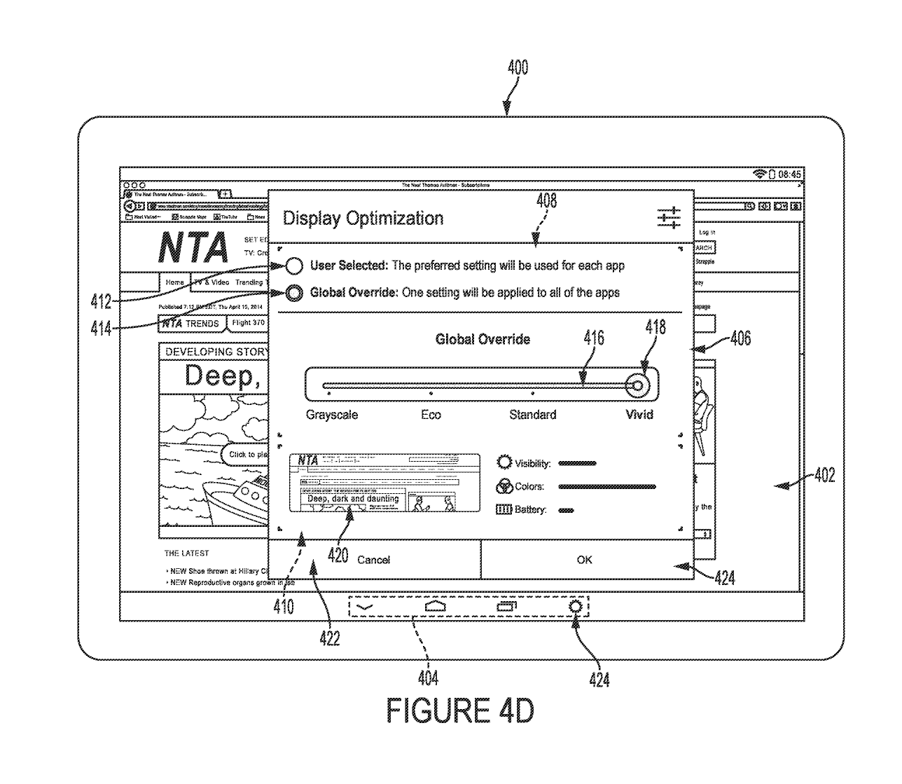

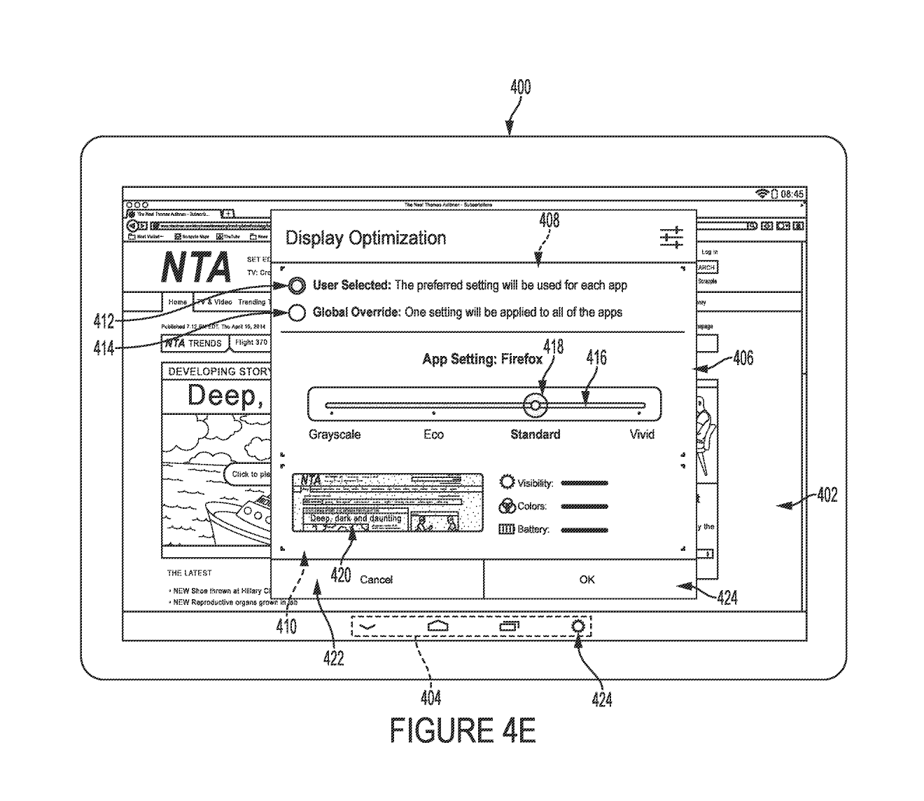

FIGS. 4A-4E show various example screenshots of user interfaces for adjusting display operation modes of a display device 400. In some implementations, the display device 400 can include the display module parameter selection system 300 shown in FIG. 3. Referring to FIG. 4A, the display device 400 includes a display screen 402 for displaying content to a viewer. In some implementations, the display screen 402 can display content received from a display controller, such as, for example, the host device processor 304 shown in FIG. 3. The display device 400 also includes a user input interface 404 for accepting user input. In some implementations, the user input interface 404 can include push buttons, touch sensitive buttons, a touch sensitive surface, etc., that the user can interact with to provide commands/data to the display device 400. In some implementations, the user interface 404 can be coupled to a user interface module, such as, for example, the user interface module 312 shown in FIG. 3.

In some implementations, user selection of various settings on the display device 400 also can be received in the form of voice commands or gestures. In some such implementations, the user interface module 312 (FIG. 3) can receive audio signals from a microphone (such as a microphone 46 shown in FIG. 8B) or image signals from a camera and use the audio signals and the image signals to detect voice commands and gestures. The voice commands and gestures can be processed by the user interface module 312 to detect user selection. In some implementations, the user can be provided selection options using audio indications such as a voice signal that lists the selectable options available to the user via a speaker (such as a speaker 45 shown in FIG. 8B). For illustration, the following description discusses example user interfaces that provide pressure sensitive buttons on the display device 400 or provide software graphical control elements such as sliders, drop-down menus, radio buttons, for selection using a touch sensitive display screen 402. However, a person having ordinary skill in the art will readily understand that other forms of user interfaces (such as voice commands and gestures) discussed above can be used in addition to, or in place of, those discussed below.

FIG. 4A shows the state of the display device 400 in which the display screen 402 displays a “Display Optimization” dialog box (hereinafter referred to as “display settings dialog box”) 406 to the user. The display settings dialog box 406 can be shown to the user in response to a user input entered via the user interface 404. For example, the user input interface 404 can include a settings icon 424, which, when pressed/activated by the user, causes the display device 400 to display the display settings dialog box 406. In some implementations, the settings icon 424 can be a persistent icon that is shown on the display screen 402 when the display screen 402 is turned on. The display settings dialog box 406 may occupy a portion of the screen of the entire display device 402. The portion of the display screen 402 not occupied by the display settings dialog box 406 can be darkened and/or inactivated. In some implementations, such as in small display devices, the display settings dialog box 406 may occupy the entire portion of the display screen 402.

The display settings dialog box 406 can include a user selection portion 408 and a feedback portion 410. The user selection portion 408 can accept user input for modifying display operation modes, while the feedback portion 410 can provide the user a preview of the effect of the currently selected display operation mode on the currently running application. For example, as shown in FIG. 4A, the user selection portion 408 includes a User Selected radio button 412 and a Global Override radio button 414. The user may select one of the User Selected radio button 412 and the Global Override radio button 414. If the user selects the User Selected radio button 412, any display parameters selected by the user would be applied to one or more of a current set of running applications. On the other hand, if the user selects the Global Override radio button 414, any display parameters selected by the user would be applied to all applications (currently running or invoked in the future) running on the display device 400. In some implementations, the display parameters also can be applied to applications for which the user has not entered specific settings. In the example shown in FIG. 4A, the Global Override radio button 414 has been selected by the user. In some implementations, additional radio buttons also may be included in the user selection portion 408. In some implementations, graphical control elements such as check boxes, split buttons, cycle buttons, slideable buttons, and drop-down menus can be provided in place of, or in addition to, the radio buttons 412 and 414 for selection of User Selected or Global Override display operation modes.

The user selection portion 408 of the display settings dialog box 406 also can include one or more selectable display operation modes. For example, as shown in FIG. 4A, the user selection portion 408 can include a four selectable display operation modes “Grayscale,” “Eco,” “Standard,” and “Vivid.” While FIG. 4A shows four selectable display operation modes, in some implementations, the display setting dialog box 406 can include more than or less than four selectable display operation modes. The four selectable display operation modes can be positioned at various locations in relation to a slide 416. A particular display operation mode can be selected by a user by sliding a slideable button 418 to a position proximate to the position of the display operation mode on the slide 416. For example, as shown in FIG. 4A, the slideable button 418 has been positioned proximate to the Standard display operation mode. In some implementations, the selection of a display operation mode may be implemented using a drop-down menu, radio-buttons, check-boxes, cycle buttons, split buttons, etc.

As mentioned above, the feedback portion 410 can provide the user a preview of the effect of the currently selected display operation mode on the currently running application. For example, the feedback portion 410 includes a snapshot 420 of a portion of a currently running application. The snapshot 420 shows a preview of the effect of the currently selected display operation mode. In some implementations, the feedback portion 410 can show the preview of the effect of the currently selected display operation mode using a generic image. In some implementations, the display device also may show the effects of the selected display operation mode on the currently running application behind the display setting dialog box 406.

In some implementations, the feedback portion 410 also can provide additional information to the user in relation to the selected display operation mode. For example, as shown in FIG. 3, the feedback portion 410 shows the predicted effect of the selected display operation mode on various display device attributes such as the “Visibility,” the “Colors,” and the “Battery” of the display device 400. The display device attribute “Visibility” can indicate the level of visibility or brightness of the content displayed on the display screen 402. The display device attribute “Colors” can indicate the relative number of colors used, or the saturation levels of colors displayed on the display screen 402. The display device attribute “Battery” can indicate the relative or absolute length of time for which the battery can provide power to the display device 400 while operating in that mode. In some implementations, additional or different display device attributes can be displayed to the user. Bars with various lengths adjacent to each of the various display device attributes can indicate the relative level of their respective display device attribute. In some implementations, other types of indicators, such as vertical bars, alpha-numerical values, etc., also can be utilized.

The display setting dialog box 406 also includes two user input portions labeled “Cancel” 422 and “OK” 424. Activating the “OK” 424 user input can cause the selected display operation mode to take effect, while activating the “Cancel” 422 user input can discard the selected display operation mode, and cause the display device 400 to operate in the previously selected display operation mode. In some implementations, activating either the “OK” 424 or the “Cancel” 422 user input can cause the display device 400 to cease displaying the display setting dialog box 406.

FIGS. 4B-4E show screenshots of various other display operation modes selected by the user. For example, FIG. 4B shows a screenshot of the display screen 402 including the display setting dialog box 406 on which the user has selected “Global Override” and the “Grayscale” display operation mode. The display device 400 provides visual feedback of the selected display operation mode by allowing the selected “Grayscale” display operation mode to take effect over the entire screen of the display device 402, in addition to the feedback portion 410. The feedback portion 410 also indicates the levels associated with various display attributes. For example, the relative levels for display attributes such as the visibility and the battery are greater than those for the “Standard” display operation mode shown in FIG. 4A, while the level for the color display attribute is less than that for the “Standard” display operation mode. In some implementations, the “Grayscale” display operation mode can be used for low power operation or for preserving charge on the battery.

FIG. 4C shows a screenshot of the display setting dialog box 406 with the user selection of “Global Override” and the “Eco” display operation mode. In some implementations, the “Eco” display operation mode can be used for low power operation while still providing some color in displaying the applications running on the display device 400. As shown in the feedback portion 410 of the display setting dialog box 406, the relative levels for the display attribute battery is greater than that for the “Standard” display operation mode shown in FIG. 4A and is less than that for the “Grayscale” display operation mode shown in FIG. 4B.

FIG. 4D shows the user selection of “Global Override” and the “Vivid” display operation mode. In the “Vivid” display operation mode, the display device 400 can display content on the display screen with high levels of brightness and colors. As shown in the feedback portion 410 of the display settings dialog box 406 in FIG. 4D, the relative levels for the display attributes colors is greater than that for any other display operation mode shown in FIGS. 4A-4C. In some implementations, displaying content with high levels of color may result in higher power consumption, as indicated by smaller battery levels in the feedback portion 410.

FIG. 4E shows a screenshot of the user selecting the “User Selected” radio button 412 instead of the “Global Override” radio button 414. Thus, any display parameters selected by the user would be applied to one or more of a current set of running applications. In some implementations, the display parameters selected by the user would be applied to the currently running in-focus application. In the example shown in FIG. 4E, the user selection of the “Standard” display operation mode is shown; however, any of the other display operation modes could also be selected. The display settings dialog box 406 also can display the name of the application to which the “User Selected” display operation mode is being associated with. For example, the display settings dialog box 406 shows that the display operation mode is being applied to the in-focus application “Firefox.” In some implementations, the display operation mode selected under “User Selected” can be applied to the in-focus application, and the display settings dialog box 406 can display the name of the in-focus application. The display device 400 can store the user selected display operation mode associated with applications in memory (an example application data structure is discussed in relation to FIG. 6C). When the user activates an application in the future, the memory can be accessed to retrieve and implement the user selected display operation mode associated with the activated application.

In some implementations, the display device 400 can allow the user to create custom display operation modes. For example, the display settings dialog box 406 can display a “Custom” display operation mode in addition to the “Grayscale,” “Eco,” “Standard,” and “Vivid” display operation modes on the slide 416. Upon selection of the “Custom” display operation mode by the user, the display device 400 can display an additional dialog box, on which the user can select custom values for various display parameters, such as, without limitations, color bit depth, color gamut, brightness, etc. The display device 400 can provide the user with the ability to define “Custom” display operation modes under both “Global Override” and “User Selected” options (or any other additional available options). The values of the display parameters selected by the user can be stored in memory. In some implementations, the values of the display parameters selected by the user can be stored in association with the in-focus application. For example, referring to FIG. 4A, if “Firefox” is the in-focus application, when the user selects “Custom” display operation mode, then the display device 400 can store the values of the display parameters selected by the user in memory in association with “Firefox” or an identity uniquely representing “Firefox.”

In some implementations, the user can launch a dialog box for selecting the desired display operation mode from a main settings menu provided by the display device, instead of from pressing/activating a persistent user interface (such as the Settings button 408) on the front of the display device, as shown in FIGS. 4A-4E.

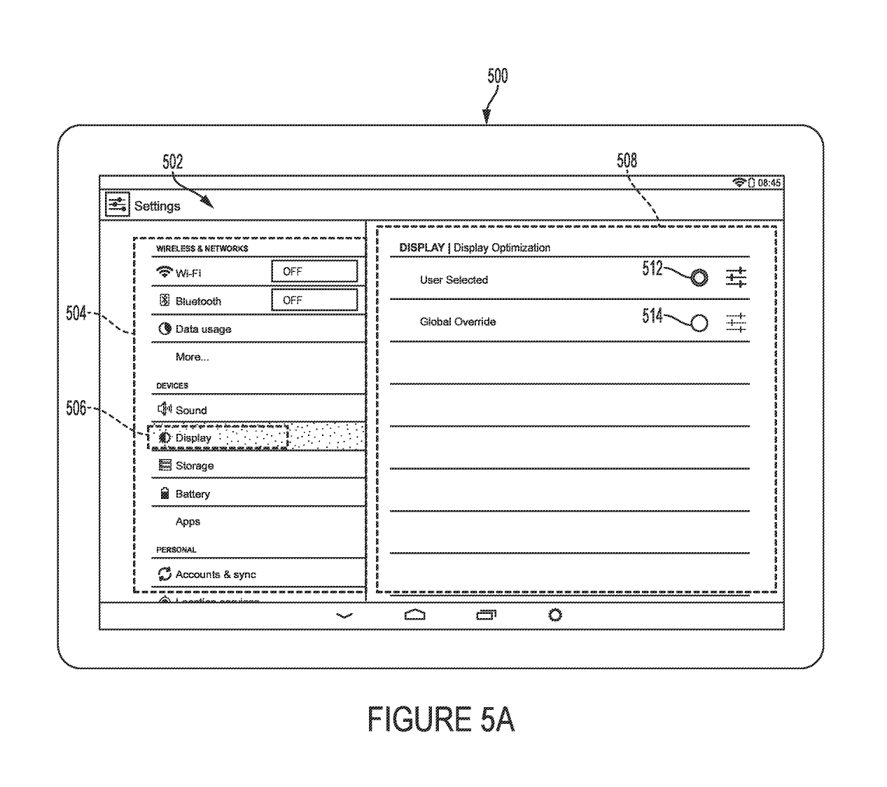

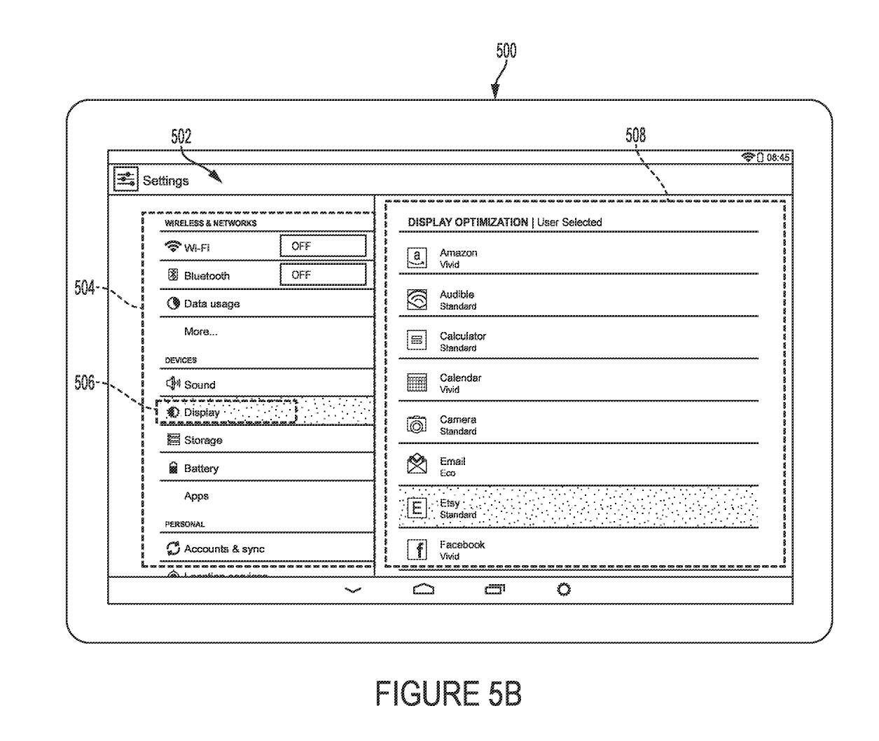

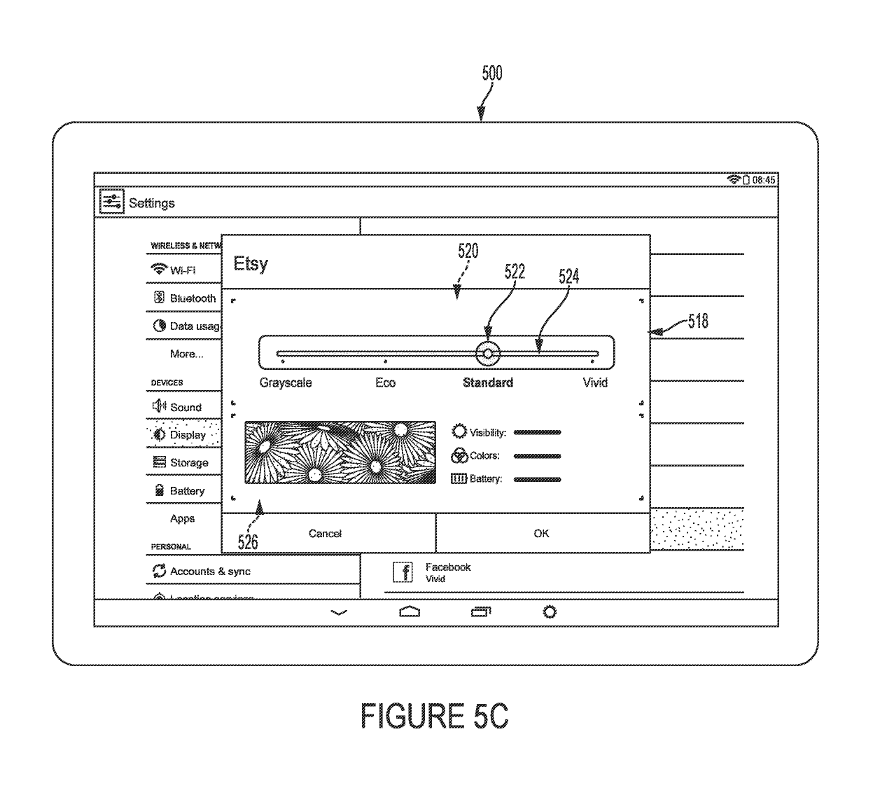

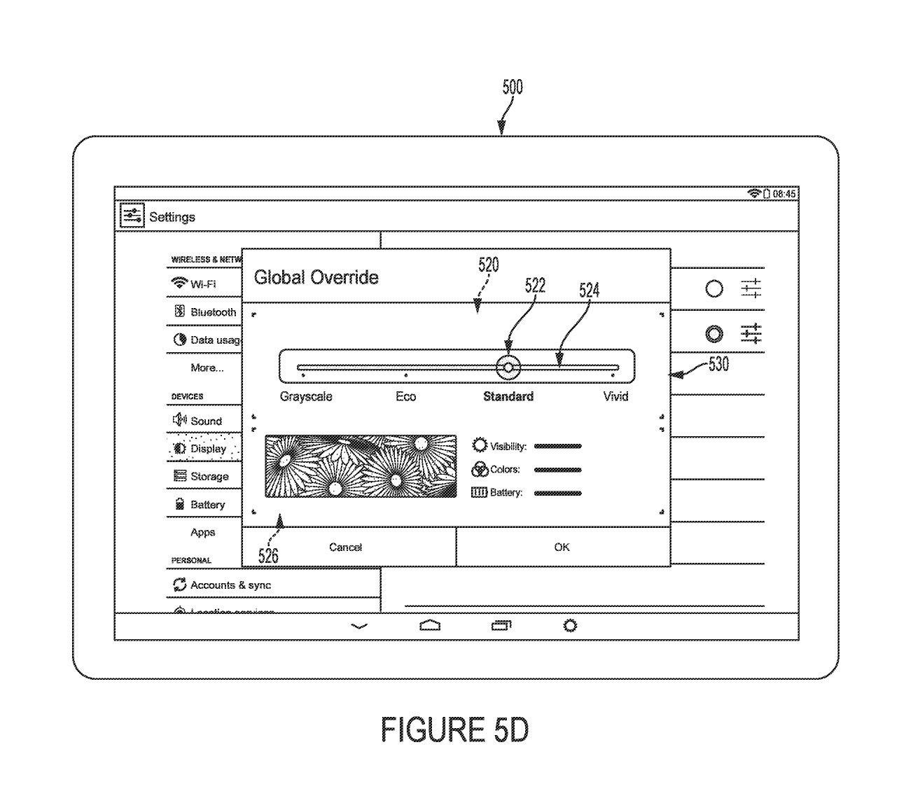

FIGS. 5A-5D show various example screenshots of user interfaces for adjusting display operation modes from a main settings menu of display device 500. FIG. 5A shows the screenshot of an example settings user interface 502 of the display device 500. The display device 500 can be similar to the display device 400 discussed above in relation to FIGS. 4A-4E. The settings user interface 502 provides the user with a menu for selecting and modifying various settings of the display device 400. For example, the settings user interface 502 provides the user a first submenu 504 including a list of various settings of the display device 500. As shown in FIG. 5A, the first submenu 504 includes a selectable option labeled “Display,” 506 which relates to display settings of the display device 500. The second submenu 508 is a result of the selection of the “Display” option 506. The second submenu 508 includes a “User Selected” radio button 512 and a “Global Override” radio button 514. The “User Selected” radio button 512 and the “Global Override” radio button 514 can be similar to the “User Selected” radio button 412 and the “Global Override radio” button 414 shown in FIG. 4A. The user may select one of the “User Selected” radio button 512 and the “Global Override” radio button 514. If the user selects the “User Selected” radio button 512, any display parameters selected by the user would be applied to one or more of a current set of running applications. On the other hand, if the user selects the “Global Override” radio button 514, any display parameters selected by the user would be applied to all applications (currently running or invoked in the future) running on the display device 500. In the example shown in FIG. 4A, the “User Selected” radio button 512 has been selected by the user. In some implementations, the second submenu 508 can include additional radio buttons corresponding to additional user options. For example, the second submenu 508 can include additional radio buttons corresponding to “Global Default” user option, in which the selected display operation mode can be used for those applications for which the user has not selected a particular display operation mode.

FIG. 5B shows a screenshot of a third submenu 516 displayed by the display device 500 as a result of the user selecting the “User Selected” radio button 512 in the second submenu 508 shown in FIG. 5A. The third submenu 516 shows a list of applications currently installed on the display device 500. One or more of the list of applications listed in the third submenu 516 can be selected by the user to view and/or modify the display operation modes associated with the selected application. The third submenu 516 also can display the current display operation mode being used for each of the applications. For example the third submenu 516 indicates that the “Standard” display operation mode is being currently set for the application “Etsy.”

FIG. 5C shows a screenshot of a second display settings dialog box 518 displayed by the display device in response to the user selecting the application “Etsy” from the third submenu 516 shown in FIG. 5B. The second display settings dialog box 518 can be similar to the display settings dialog box 406 discussed above in relation to FIG. 4A, in that the second display settings dialog box 518 also includes a user selection portion 520 and a feedback portion 526. The user selection portion 520 allows the user to position a slideable radio button 522 over a slide proximate to the desired display operation mode (“Grayscale,” “Eco,” “Standard” or “Vivid”). The feedback portion 526 shows a preview of the effect of the currently selected display operation mode. In contrast to the feedback portion 410 shown in FIG. 4A, which showed the preview of a portion of the currently running or in-focus application, the feedback portion 526 shown in FIG. 5C instead shows the effect of the currently selected display operation mode on a preselected image. However similar to the feedback portion 410 shown in FIG. 4A, the feedback portion 526 shown in FIG. 5C shows the predicted effect of the selected display operation mode on various display device attributes such as the “Visibility,” the “Colors,” and the “Battery” of the display device 500. In some implementations, the preselected image can include an image, stored in memory, of the currently running or in-focus application. In some implementations, the preselected image can be a generic image. Once the user has selected the desired display operation mode, the user can activate the “OK” user input. The “Cancel” user input can allow the user to exit the second display setting dialog box 518 without making any changes to the display operation modes.

FIG. 5D shows a screenshot of a third display settings dialog box 530 displayed by the display device 500 in response to the user selecting the “Global Override” radio button 514 in the second submenu 508 shown in FIG. 5A. The third display setting dialog box 530 is similar to the second display settings dialog box 518 shown in FIG. 5C, in that the third display settings dialog box 530 also includes a user selection portion 520 allowing the user to select a display operation mode, and a feedback portion 526 providing a preview of the selected display operation mode. However, the display operation mode selected by the user in the third display settings dialog box 530 are applied globally to all the applications running on the display device 500.

FIGS. 6A-6D show various example data structures that can be utilized by a display device for display operation mode selection. For example the data structures shown in FIGS. 6A-6D can be utilized by the display module parameter selection system 300 shown in FIG. 3.

FIG. 6A shows an example display capability data structure 600. The display capability data structure 600 includes a plurality of display parameters 602. For each display parameter 602, the display capability data structure 600 includes one or more capability values 604. The display parameters 602 represent the various characteristics that can be adjusted to change the appearance of a displayed image or the way in which images and video are rendered on an electronic display. For example, display parameters 602 can include frame rate, color bit depth, color gamut, percentage of color gamut, maximum brightness levels, white point, gamma, the number of subframes or bit-planes per image frame, or any other adjustable display setting or characteristic. The display capability data structure 600 can include any number of display parameters 602.

For each display parameter 602, the display capability data structure 600 also includes capability values 604 representing the specific values that the display is able to implement. For example, a display may have a maximum frame rate of about 60 Hz, but also may operate at a frame rate of about 30 Hz, 24 Hz, or 1 Hz. There may be intermediate values, such as about 16 Hz, for example, at which the display is not capable of operating, and these intermediate values will not be present in the display capability data structure 600. In some implementations, the display parameters 602 and the capabilities values 604 can be permanent. In other implementations, it may be possible to modify some or all of the values in the display capability data structure 600, for example in response to a firmware update impacting the performance of the display.

In some implementations, the display parameters 602 and capability values 604 in the display capability data structure 600 may be set when the display is manufactured. For example, a computing device including a display can have display capability data structure 600 included when the computing device is assembled. If the manufacturer later chooses to produce the device with a different display, such as a display from a different vendor or an updated version of an earlier display, the display capability data structure 600 on the later devices can be altered to account for any changes in the abilities of the updated display. The manufacturing process can be simplified because applications do not need to be rewritten for these changes and the operating system of each device produced will have access to an accurate display capability data structure 600 from the time the device is manufactured.

FIG. 6B shows an example display operation mode data structure 620. The display operation mode data structure 620 includes one or more display operation modes 622. For each display operation mode 622, the display operation mode data structure includes values for one or more display parameters 624. In some implementations, some or all of the display parameters 624 can correspond to the display parameters 602 of the display capability data structure 600 shown in FIG. 6A.

In some implementations, the display operation modes 622 can correspond to the display operation modes discussed above in relation to FIGS. 4A-4E and FIGS. 5A-5D. For example, Standard display operation mode 622 and its associated display parameters 624 can represent the display operating characteristics that should be implemented by the display when the user selects the Standard display operation mode. Similarly, various values for the display parameters 624 for display operation modes 622 such as Grayscale, Eco, and Vivid are shown in FIG. 6B.

In some implementations, the display operation mode data structure 620 can be modified. For example, a user of a computing device may have unique preferences for the characteristics of the display. The user can therefore create a custom display operation mode 622 and corresponding values for the display parameters 624, all of which can be stored in the display operation mode data structure 620. Any number of such custom display operation modes 622 can be added to the data structure 620. A user also may delete display operation modes 622 and their corresponding display parameters 624 from the display operation mode data structure 620. In some implementations, the display operation mode data structure 620 may be stored at a display controller, instead of a host device processor (such as the host device processor 304 shown in FIG. 3). The display controller can receive the currently selected display operation mode from the host device processor, and determine the specific values for the various display parameters based on the display operation mode data structure 620.

FIG. 6C shows an example application data structure 640. For example, the application data structure 640 includes information corresponding to at least some of the applications that can be executed by the host device processor 304 and displayed by the electronic display 302 shown in FIG. 3. In some implementations, the application data structure 640 can include the display operation modes selected by the user for the particular application. For example, the application data structure 640 can include the display operation modes selected by the user as shown in FIGS. 5A-5D. The number of applications included in the application data structure 640 is not limited to the ones shown in FIG. 6C, and can include all of the applications installed in the display device or those applications for which allow user selected display operation modes.

The application data structure 640 includes a list of applications 642 and the corresponding display operation modes 644. The application data structure 640 also includes user selected 646 and default 648 display operation modes. The user selected display operation mode 646 can include the display operation mode selected by the user, while the default display operation mode 648 can include the display operation mode used for the corresponding application when no user selected display operation mode is present. In some implementations, the default display operation mode 648 as well as the user selected display operation mode may be overridden by the Global Override display operation mode selected by the user (as discussed in relation to FIG. 4A).

FIG. 6D shows an example current display operation mode data structure 660. The current display operation mode data structure includes the display operation mode being currently used for displaying content on the display device. The current display operation mode data structure 660 can indicate whether the current user selection includes a “Global Override” or a “User Selection.” In addition, the current display operation mode data structure 660 can indicate the display operation mode selected for each of these two selections. For example, FIG. 6D shows that the user has currently selected “Global Override” and a “Standard” display operation mode. However, if the user were to select “User Selection,” the current display operation mode data structure 660 would store “User Selection” in place of “Global Override.” In such instances, the data structure may not include the current display operation mode. Instead, the current display operation mode can be accessed from the application data structure 640 discussed above in relation to in FIG. 6C.

In some implementations, the display capability data structure 600, the display operation mode data structure 620, the application data structure 640, and the current display operation mode data structure 660 can be stored and maintained in the electronic display 302 (FIG. 3). In particular, the display controller 314 can maintain these data structures, and utilize the values within the data structure, as per the display operation mode being used, to display image data. In some implementations, the host device processor 304 (FIG. 3) can provide the display controller 314 directly with the display operation mode to be used or provide the display controller 314 with the identity of the in-focus application, which the display controller 314 can use to determine the display operation mode.

In some implementations, the display operation mode user interface, such as, for example, the display settings dialog box 406 shown in FIGS. 4A-4E and the settings user interface 502 shown in FIGS. 5A-5D, can provide the user an option for automatic selection of display operation modes. As discussed above, the control logic 310 (shown in FIG. 3) can automatically determine appropriate or optimal values for various display parameters based, at least, on the content to be displayed. In some implementations, the user interface can provide the user an option to allow the display device to automatically select the appropriate display operation mode. For example, the dialog box 406 (shown in FIGS. 4A-4E) or the second submenu 508 (shown in FIG. 5A), can display the option “Automatic” in addition to the “User Selected” and “Global Override” options. Selection of the “Automatic” option causes the display device to display the content based on the display operation mode automatically determined by the control logic 310.

In some implementations, the user interface can present the user with a “Preferred Display operation mode” selectable option in addition to the other display operation modes. For example, the slide 416 (shown in FIGS. 4A-4E) and the slide 524 (shown in FIGS. 5C and 5D) can include a “Preferred” display operation mode in addition to the “Grayscale,” “Eco,” “Standard,” and “Vivid” display operation modes. The “Preferred” display operation mode may be selected if the user wishes to rely on the display device to determine the appropriate display operation mode. As discussed above, the display control module 310 can automatically determine the appropriate or optimal display operation mode for the content being displayed. Thus, when the user selects the “Preferred” display operation mode, the display device can use the display operation mode determined by the control logic 310 to display the content. In some implementations, the user interface can provide a preview of the effect of the “Preferred” display operation mode on the content to the user.

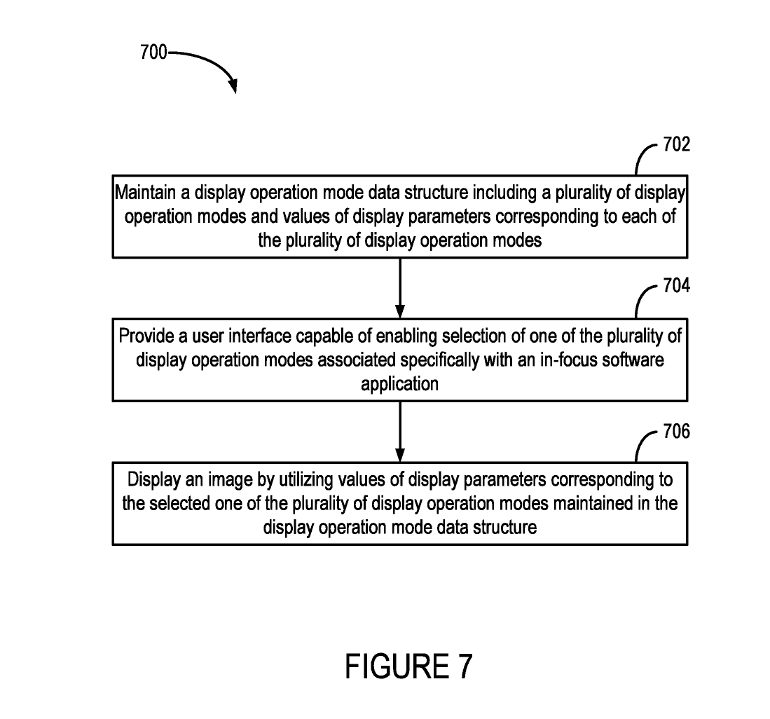

FIG. 7 shows an example flow diagram of a process 700 for displaying an image on an electronic display shown in FIG. 3. In particular, the process 700 includes maintaining a display operation mode data structure including a plurality of display operation modes and values of display parameters corresponding to each of the plurality of display operation modes (stage 702), providing a user interface capable of enabling selection of one of the plurality of display operation modes associated specifically with an in-focus software application (stage 704); and displaying an image by utilizing values of display parameters corresponding to the selected one of the plurality of display operation modes maintained in the display operation mode data structure (stage 706).

The process 700 includes maintaining a display operation mode data structure including a plurality of display operation modes and values of display parameters corresponding to each of the plurality of display operation modes (stage 702). Examples of this process stage have been discussed above in relation to FIGS. 3 and 6A-6D. In particular, as discussed above in relation to FIG. 3, in some implementations, the display control module 310 can maintain information on the display information such as the display requirements of each application that can be run on a host device processor 304. Alternatively, in some implementations, the display controller 314 controlling the electronic display 302 can maintain the display operation mode data structure. The data structures maintained by the display control module 310 or the display controller 314 can include the data structures shown in FIGS. 6A-6D.

The process 700 further includes providing a user interface capable of enabling selection of one of the plurality of display operation modes associated specifically with an in-focus software application (stage 704). Examples of this process stage have been discussed above in relation to FIGS. 4A-4E. In particular, FIGS. 4A-4E show a display settings dialog box 406 provided to the user for selecting various display operation modes such as “Grayscale,” “Eco,” Standard,” and “Vivid,” for an in-focus application running on the display device 400.

The process 700 also includes displaying an image by utilizing values of display parameters corresponding to the selected one of the plurality of display operation modes maintained in the display operation mode data structure (stage 706). Examples of this process stage have been discussed above in relation to FIG. 3 and FIGS. 6A-6D. In particular, the display controller 314 can utilize the display parameters associated with the selected display operation mode (one example of which is shown in FIG. 6B) for displaying an image on the electronic display 302.

FIGS. 8A and 8B show system block diagrams of an example display device 40 that includes a plurality of display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be capable of including a flat-panel display, such as plasma, electroluminescent (EL) displays, OLED, super twisted nematic (STN) display, LCD, or thin-film transistor (TFT) LCD, or a non-flat-panel display, such as a cathode ray tube (CRT) or other tube device. In addition, the display 30 can include a mechanical light modulator-based display, as described herein.

The components of the display device 40 are schematically illustrated in FIG. 8B. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 8A, can be capable of functioning as a memory device and be capable of communicating with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to any of the IEEE 16.11 standards, or any of the IEEE 802.11 standards. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G, or further implementations thereof, technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29 is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements. In some implementations, the array driver 22 and the display array 30 are a part of a display module. In some implementations, the driver controller 29, the array driver 22, and the display array 30 are a part of the display module.

In some implementations, the driver controller 29, the array driver 22, and the display array 30 are appropriate for any of the types of displays described herein. For example, the driver controller 29 can be a conventional display controller or a bi-stable display controller (such as a mechanical light modulator display element controller). Additionally, the array driver 22 can be a conventional driver or a bi-stable display driver (such as a mechanical light modulator display element controller). Moreover, the display array 30 can be a conventional display array or a bi-stable display array (such as a display including an array of mechanical light modulator display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40. Additionally, in some implementations, voice commands can be used for controlling display parameters and settings.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An electronic device, comprising:
a display capable of generating images according to a plurality of variable display parameters;
a processor coupled to the display, capable of:
executing a plurality of software applications on the electronic device; and
a display control module capable of:
maintaining a display operation mode data structure including a plurality of display operation modes and values of display parameters corresponding to each of the plurality of display operation modes;
providing a user interface capable of enabling selection of one of the plurality of display operation modes associated with an in-focus software application; and
transmitting the values of display parameters corresponding to one of the plurality of display operation modes to the display.

2. The electronic device of claim 1, wherein the display control module is capable of enabling selection of one of the plurality of display operation modes to apply specifically to the in-focus software application.

3. The electronic device of claim 1, wherein the display parameters include at least one of: color gamut, bit depth, and frame rate.

4. The electronic device of claim 1, wherein the display control module is capable of providing the user interface in response to input received via a persistent display operation mode settings input of the electronic device.

5. The electronic device of claim 1, wherein the display control module is capable of providing a visual feedback of the effect of the selected one of the plurality of the display operation modes on a currently running application.

6. The electronic device of claim 5, wherein the display control module is capable of providing a visual feedback of at least a portion of an image of the currently running software application modified by the selected one of the plurality of the display operation modes.

7. The electronic device of claim 5, wherein the display control module is capable of providing a visual feedback of a generic image modified by the selected one of the plurality of the display operation modes.

8. The electronic device of claim 1, wherein:
the user interface is capable of enabling selection of one of the plurality of display operation modes for one of the plurality of software applications stored on the electronic device; and
the display control module is capable of transmitting the values of the display parameters to the display when the one of the plurality of software applications stored on the electronic device is active.

9. The electronic device of claim 8, wherein the display control module is capable of maintaining an application data structure including a list of the plurality of software applications stored on the display device and the selected one of the plurality of display operation modes corresponding to the each of the plurality of software applications.

10. The electronic device of claim 1, wherein the user interface is capable of enabling selection of one of the plurality of display operation modes as a global override display operation mode.

11. The electronic device of claim 10, wherein the display control module is capable of transmitting the display parameters of the selected one of the plurality of display operation modes to the display for all software applications running on the electronic device.

12. An electronic device, comprising:
a processor capable of:
executing a plurality of software applications on the electronic device;
a display control module capable of:
providing a user interface capable of enabling selection of one of the plurality of display operation modes associated with an in-focus software application; and
transmitting the selected one of the plurality of display operation modes to a display, and
a display capable of:
maintaining a display operation mode data structure including the plurality of display operation modes and the values of display parameters corresponding to each of the plurality of display operation modes;
receiving the selected one of the plurality of display operation modes from the display control module, and
generating images according to the values of display parameters corresponding to the selected one of the plurality of display operation modes received from the display control module.

13. The electronic device of claim 12, wherein the user interface is capable of enabling selection of one of the plurality of display operation modes to apply specifically to the in-focus software application.

14. The electronic device of claim 12, wherein the display parameters include at least one of: color gamut, bit depth, and frame rate.

15. The electronic device of claim 12, wherein the display control module is capable of providing the user interface in response to input received via a persistent display operation mode settings input of the electronic device.

16. The electronic device of claim 12, wherein the display control module is capable of providing a visual feedback of the effect of the selected one of the plurality of the display operation modes on one of an image output by a currently running software application and a generic image.

17. The electronic device of claim 12, wherein:
the user interface is capable of enabling selection of one of the plurality of display operation modes for one of the plurality of software applications stored on the electronic device; and
the display control module is configured to transmit the selected one of the plurality of display operation modes to the display when the one of the plurality of software applications stored on the electronic device is active.

18. The electronic device of claim 17, wherein the display control module is capable of maintaining an application data structure including a list of the plurality of software applications stored on the electronic device and the selected one of the plurality of display operation modes corresponding to the each of the plurality of software applications.

19. A method for displaying an image on a display device, comprising:
maintaining a display operation mode data structure including a plurality of display operation modes and values of display parameters corresponding to each of the plurality of display operation modes;
providing a user interface capable of enabling selection of one of the plurality of display operation modes associated with an in-focus software application; and
displaying an image by utilizing values of display parameters corresponding to the selected one of the plurality of display operation modes maintained in the display operation mode data structure.

20. The method of claim 19, wherein providing a user interface capable of enabling selection of one of the plurality of display operation modes associated with an in-focus software application includes enabling selection of one of the plurality of display operation modes to apply specifically to the in-focus software application.

21. The method of claim 19, wherein maintaining a display operation mode data structure including a plurality of display operation modes and values of display parameters corresponding to each of the plurality of display operation modes includes maintaining the display operating mode data structure at a host device processor communicably connected to a display controller controlling the operation of an electronic display.

22. The method of claim 19, wherein providing a user interface capable of enabling selection of one of the plurality of display operation modes associated with an in-focus software application includes providing the user interface in response to input received via a persistent display operation mode settings input of the display device.

23. The method of claim 19, wherein providing a user interface capable of enabling selection of one of the plurality of display operation modes associated with an in-focus software application includes providing the user interface in response to input received via a main settings menu of the display device.

24. The method of claim 19, wherein providing a user interface capable of enabling selection of one of the plurality of display operation modes associated with an in-focus software application includes providing a visual feedback of the effect of the selected one of the plurality of the display operation modes on a currently running application.

25. The method of claim 19, further comprising maintaining an application data structure including a list of the plurality of applications stored on the display device and the selected one of the plurality of display operation modes corresponding to the each of the plurality of applications.

26. A non-transitory computer readable storage medium having instructions encoded thereon, which when executed by a processor cause the processor to perform a method for displaying an image on a display device, comprising:
maintaining a display operation mode data structure including a plurality of display operation modes and values of display parameters corresponding to each of the plurality of display operation modes;
providing a user interface capable of enabling selection of one of the plurality of display operation modes associated with an in-focus software application; and
displaying an image by utilizing values of display parameters corresponding to the selected one of the plurality of display operation modes maintained in the display operation mode data structure.

27. The non-transitory computer readable storage medium of claim 26, wherein providing a user interface capable of enabling selection of one of the plurality of display operation modes associated with an in-focus software application includes providing the user interface capable of enabling selection of one of the plurality of display operation modes to apply specifically to the in-focus software application.

28. The non-transitory computer readable storage medium of claim 26, wherein providing a user interface capable of enabling selection of one of the plurality of display operation modes associated with an in-focus software application includes providing the user interface in response to input received via a persistent display operation mode settings input of the display device.

29. The non-transitory computer readable storage medium of claim 26, wherein providing a user interface capable of enabling selection of one of the plurality of display operation modes associated with an in-focus software application includes providing a visual feedback of the effect of the selected one of the plurality of the display operation modes on a currently running application.

30. The non-transitory computer readable storage medium of claim 26, wherein the method further includes maintaining an application data structure including a list of the plurality of applications stored on the display device and the selected one of the plurality of display operation modes corresponding to the each of the plurality of applications.
